(19) United States
(12) Patent Application Publication
(10) Pub. No.: US 2026/0194978 A1
(43) Pub. Date: Jul. 9, 2026

(54) HAPTIC HOLOGRAM

(71) Applicant: Carl Zeiss Jena GmbH, Jena (DE)

(72) Inventors: Martin Thom, Jena (DE); Marc Junghans, Jena (DE); Viktor Schütz, Jena (DE); Siemen Kühl, Jena (DE); Petr Vojtisek, Jena (DE); Roman Kleindienst, Jena (DE)

(21) Appl. No.: 18/730,279

(22) PCT Filed: Jan. 20, 2023
(86) PCT No.: PCT/EP2023/051358

§ 371 Date: Jul. 18, 2024

(30) Foreign Application Priority Data
Jan. 20, 2022 (DE) 10 2022 101 316.2

(51) Int. Cl. G06F 3/01; G03H 1/22; H04R 1/02; H04R 1/40

(52) U.S. Cl. CPC G06F 3/016; G03H 1/2202; G06F 3/017; H04R 1/028; H04R 1/403; G03H 2001/2228; G03H 2223/16; H04R 2499/15

(57) ABSTRACT

In a first aspect, the invention relates to a system for generating a haptic perception and a holographic image. The system comprises a light source for emitting light and a main body comprising a substrate and at least one holographic optical element. The light source and the main body comprising the holographic optical element are designed to generate a holographic image in an interaction region. At the same time, the system comprises one or more sound transducers for emitting sound waves in the direction of the interaction region such that pressure fluctuations are haptically palpable within the interaction region.

The system is characterized in that the substrate is situated between the one sound transducer or the plurality of sound transducers and the interaction region and comprises sound channels, formed as openings, through which the sound can propagate.

In a further aspect, the invention relates to the use of the system according to the invention for generating a holographic image and a haptic perception.

In a first aspect, the invention relates to a system for generating a haptic perception and a holographic image. The system comprises a light source for emitting light and a main body comprising a substrate and at least one holographic optical element. The light source and the main body comprising the holographic optical element are designed to generate a holographic image in an interaction region. At the same time, the system comprises one or more sound transducers for emitting sound waves in the direction of the interaction region such that pressure fluctuations are haptically palpable within the interaction region.

The system is characterized in that the substrate is situated between the one sound transducer or the plurality of sound transducers and the interaction region and comprises sound channels, formed as openings, through which the sound can propagate.

In a further aspect, the invention relates to the use of the system according to the invention for generating a holographic image and a haptic perception.

### BACKGROUND AND PRIOR ART

Holography is a branch of optics which considers the production and construction of three-dimensional, real images and which can be considered to be an extension of photography. While a photographic image is only a two-dimensional representation of an object, holography leads to three-dimensional recordings. In this context, a different type of recording of the object takes effect. In photography, a film for example indicates an intensity of the light which reaches said film at each point. In holography, by contrast, additional optical information of an object is considered on the basis of the wavefronts emanating from the object, in particular by way of the amplitude and phase. Further information which can be registered in a holographic recording relates to the color spectrum and the polarization, whereby there is an increase in the variety of design options. Conventionally, the recorded image is referred to as a hologram while an image generated on the basis of the hologram by way of an appropriate reconstruction is referred to as a holographic image.

A technological development in holography provides for the generation and display of holographic images freely in space. In the process, use is usually made of holographically created microstructures which are used to deflect the light with a specific wavelength spectrum or a specific angle of incidence. To an observer, real objects or animations may appear freely in space. In this context, reference is made to real images visible in a holographic eyebox. In comparison with a two-dimensional image on a display, such a representation is advantageously visible from different sides-thus, the user can observe the holographic image from different perspectives, with the result that a realistic picture arises.

The ability to additionally haptically sense, i.e. “feel”, such holographic images in space would be advantageous. Especially within the scope of operating concepts (HMI), this would be advantageous in that tactile feedback would be enabled at the same time as the optical perception. For example, holographic operating elements (keys, buttons, etc.) which are not only able to be displayed optically but also felt by a user at the same time would be conceivable.

For the provision of haptic feedback, the prior art has disclosed the use of ultrasound emitters which can output perceivable feedback to the user with the aid of ultrasound. To this end, the ultrasonic signals can be amplitude-modulated by a low frequency and incident on the skin of a user. The ultrasonic signals act as pressure fluctuations on the skin and are haptically perceivable.

For example, U.S. Pat. No. 9,612,658 B2 discloses an apparatus for generating a sound field for tactile sensations. To this end, a hand of a user intended to perceive a tactile signal can be brought above an electronic visual display. An array of ultrasound transducers intended to generate the sound field above the electronic visual display is positioned below the electronic visual display.

The movement of the hand can be tracked using a hand tracker in order to enable an appropriate pressure sensation in different regions.

WO 2014/181084 A1 also discloses an apparatus for generating a sound field by way of an array of ultrasound transducers. To this end, a method is proposed for the generation of points in a sound field, which have a fixed spatial relationship with respect to one another or with respect to the array.

DE 102017116012 A1 discloses a display apparatus which in addition to the output of an optical picture is able to additionally provide tactile feedback by generating a sound field. The display apparatus comprises an optical display with a plurality of pixels which create an optical picture on the front side of the display apparatus.

A plurality of sound transducers preferably arranged on a back side of the display are provided to generate a palpable sound field in a space in front of the display. In preferred embodiments, control signals for the sound transducers are pre-distorted on the basis of acoustic properties of the display in order thus to ensure a compensation of or reduction in the acoustic distortion caused by the display. An alternative embodiment provides a display whose pixels comprise an acoustically transparent region next to three sub-pixels for the RGB colors. By preference, the sound transducers are aligned with the acoustically transparent regions such that a sound transducer in each case covers an acoustically transparent region at least in part. In the embodiment, the size and arrangement of the acoustically transparent regions are consequently specified by the pixel array of the display, but this has a disadvantageous effect on a flexible generation of a sound field in the space in front of the display.

With regards to the combination of holographic images with haptic feedback, the prior art has only disclosed sporadic attempts to date, especially in the context of the provision of operating elements in vehicles.

For example DE 10 2016 214 478 A1 discloses a holographic display attached to a steering wheel of a vehicle. Haptic feedback for the event of an operation of the holographic display can be implemented by means of an ultrasound pulse. If the ultrasound pulse is focused on the position within the holographic display operated by the user, then this can provide the user with a haptic feedback which may simulate the presence of a real button. For example, the ultrasonic array for generating the ultrasound pulse can be arranged in the steering column and/or in the region of the dashboard.

DE 2016210213 A1 describes a method for the interaction of an occupant with operating elements of a vehicle. To this end, haptically experienceable ultrasound pulses whose modulated individual signals superimpose constructively on a surface of a virtual object are generated by means of a multiplicity of ultrasound transducers, which may be arranged in the form of an array. For example, the virtual object may constitute an operating device. In this manner, operating gestures for the user should be performed freely in space within the scope of highly automated driving operation and should be connected to a haptic perception.

DE 102017211378 A1 discloses a user interface for a vehicle comprising a display apparatus having a holography apparatus. A representation is generated freely in space by way of the holography apparatus; it is referred to as a hologram. The user interface may comprise an ultrasonic loudspeaker arrangement for generating haptically experienceable ultrasound pulses on the skin of the user. Hence, a user can notice a perceptible excitation by the ultrasound, and so haptic feedback results when the hologram is touched. The user should experience less distraction as they receive direct feedback due to the interaction with the hologram.

However, there are several disadvantages linked to the apparatuses and methods, known from the current prior art, for the haptic perception of a holographic image.

In particular, the integration of the required components for providing a tactile sensation such as a holographic image in the respective vehicle systems is complex, and this has a disadvantageous effect on the production outlay and the control.

Additionally, the known systems have limitations with regards to the use options, which arise from the fact that certain interaction gestures prevent a simultaneous haptic sensation and holographic representation.

### OBJECT OF THE INVENTION

The object of the invention is to provide a system for haptically perceiving a holographic image that eliminates the disadvantages of the prior art. In particular, it is an object of the invention to provide a system for haptically perceiving holographic images that is distinguished by a compact structure and an efficient generation of holographic images and haptic perception with many interaction options, by preference using simple and cost-effective means.

### SUMMARY OF THE INVENTION

The object is achieved by the features of the independent claims. Preferred embodiments of the invention are described in the dependent claims.

In a first aspect, the invention relates to a system for generating a haptic perception and a holographic image in an interaction region, comprising
a. a light source for emitting light,
b. a main body comprising a substrate and at least one holographic optical element, with the light source and the main body being designed to generate a holographic image in the interaction region, and also
c. one or more sound transducers for emitting sound waves in the direction of the interaction region such that pressure fluctuations are haptically palpable within the interaction region, characterized in that the substrate is situated between the one sound transducer or the plurality of sound transducers and the interaction region, and the substrate comprises one or more sound channels, with the sound waves propagating at least in part through the one or more sound channels in the direction of the holographic image.

A particularly compact structure of the system is rendered possible by the arrangement of the components, especially by a placement of the substrate between the sound transducers and the interaction region. For example, the sound transducers may be present arranged directly behind the main body comprising the holographic optical element. There is no need for a separate integration of the components in different regions of an application system, for example in a vehicle.

As a result of positioning the components for generating the holographic image and haptic perception on an optical and acoustic axis, it is moreover possible to avoid disadvantageous shadowing effects in the case of which, for example, the generation of the holographic image or haptic perception is impaired when an operating gesture is performed in the interaction region.

Instead, both the light propagation for generating a holographic image and the sound propagation for generating a haptic perception in the interaction region are implemented starting from the substrate or main body.

Access to the interaction region is advantageously possible from any direction in front of the main body or substrate, without this leading to possible impairments in the quality of the holographic image or a haptic perception.

The provision of the sound transducers behind the main body or substrate from the view of the interaction region does not lead to any attenuation of the haptic experience here. Instead, the sound channels according to the invention ensure that the sound waves emitted by one or more sound transducers propagate in the direction of the holographic image largely without distortion or attenuation, with the result that an optimal haptic sensing thereof is rendered possible. In particular, the sound waves are advantageously used particularly efficiently as an impairment of the propagation of the sound waves is prevented by the sound channels.

Moreover, there are great design freedoms in relation to the substrate on account of the provision of the sound waves. In particular, use can be made of materials such as optical glasses or plastics which are optimized in relation to guiding light for the purpose of generating holographic images but which may prevent sound propagation. Additionally, a construction of any desired robustness can be chosen for the substrate, without this leading to significant pressure and/or intensity losses in the sound waves and consequently to a reduction in a haptic perception.

Instead, it may be preferable to introduce appropriate sound channels into substrates whose geometry and/or size are optimized depending on the optical requirements, without having to accept quality losses in relation to a simultaneous haptic experience.

It is also advantageous that particularly targeted and precise pressure maxima and pressure minima can be generated in the interaction region by means of the system according to the invention. Thus, with the aid of an appropriate positioning of the sound channels, a desired pressure can preferably be ensured in certain areas of the interaction region by way of interferences. Consequently, the arrangement of the sound channels itself can be used for the desired formation of constructive and destructive interferences for the purpose of generating pressure fluctuations for a haptic perceivability of a holographic image.

The system according to the invention was found to be particularly advantageous in the field of human-machine interaction (abbreviated HMI). Thus, information in the form of a haptic feedback is transmitted particularly effectively by way of sound waves which preferably propagate in the direction of the holographic image. The combination with a holographic image allows the provision of a variety of pieces of information in the process. Advantageously, the operation can be designed to be safer and more efficient by way of the haptic feedback. For example, an operation can be implemented at least partially without visual contact since the user experiences feedback about the operation and/or the operating element by their sense of touch. This increases safety in particular, for example when a transportation means such as an automobile is used.

Moreover, the system according to the invention can advantageously be provided in a particularly simple, compact and cost-effective fashion.

Within the meaning of the invention, a holographic image preferably denotes an optical image generated with the aid of a holographic optical element. In this context, this may relate to any desired content, for example information, animations or a projection of an object or operating element. In preferred embodiments, the holographic image can be a three-dimensional projection of an object situated freely in space, especially in the interaction region. The holographic image can represent an object statically or dynamically. For the embodiment, it is preferable that the object appears freely in space to the observer, i.e. preferably at a distance in front of the main body. In this context, this preferably relates to a real image, which is visible in what is known as a holographic eyebox. In comparison with a two-dimensional image generated on a display, such a representation is advantageously visible from different sides. Thus, the observer can preferably observe the holographic image from different perspectives, with the result that a realistic picture arises. In preferred embodiments, the holographic image may appear at a distance of more than 1 mm, 2 mm, 5 mm, 10 mm, 2 cm, 5 cm or more in front of the main body comprising the substrate and the at least one holographic optical element.

In further embodiments, the holographic image can be generated on a projection surface, wherein the projection surface can be a transparent, a partially transparent or a non-transparent surface. For example, the holographic image may represent an operating field, a joystick, a keyboard and/or a trackball, without being limited to these examples.

In general, a haptic perception preferably denotes the active sensing of the size, contour, texture, temperature and/or mass of an object with the aid of the surface sensitivity of the skin, while a tactile perception relates to a passive perception of mechanical stimuli. The surface sensitivity of the skin preferably denotes the sensitivity of the skin to external stimuli, as imparted by receptors. In particular, it comprises the sense of touch, which is provided by mechanoreceptors, inter alia. In preferred embodiments, the haptic perception may comprise sensing of a real holographic image, for example the contours thereof. However, it may likewise be preferable that local pressure fluctuations for a haptic/tactile perception are generated only in spatial proximity to the perceptible holographic image. For example, it may be preferable to project a holographic image onto a screen and generate haptic perceptions above the screen, said perceptions corresponding to the optical content projected onto the screen (for example to operating fields).

In the context of the invention, the phrases “haptic perception”, “tactile perception”, “haptic feedback”, “haptic sensation”, “haptic signal” and/or “haptics” can be used synonymously and in particular denote the perceptions which can be imparted by (ultrasound) pressure fluctuations in the air.

By preference, the interaction region denotes a spatial region in which a holographic image is optically perceived by a user and a haptic/tactile perception is rendered possible at the same time. By preference, the interaction region can be expanded or reduced in size by respective arrangements of components of the system and/or by settings made. For example, the intensity of sound is known to reduce with the square of the distance. For example, increasing the intensity of the sound transducers can thus increase the size of the interaction region. Specific arrangements of the sound channels can also expand the interaction region. Accordingly, the interaction region can be reduced in size by a reversal. Additionally, the interaction region can be increased in size or reduced in size by a positioning of the light source and/or the holographic optical elements.

In further preferred embodiments, the interaction region may comprise an eyebox. By preference, the eyebox denotes a plane or a spatial region in which the holographic image is perceptible to a viewer or user as a virtual image. The virtual image plane, i.e. the plane on which the virtual image is generated, can be arranged on or behind a projection surface.

A light source comprises all types of luminous means used to convert electrical energy into light. The light source is preferably configured to emit light in the direction of the main body. In particular, the main body and the light source are designed to generate the holographic image. By preference, the provision of the holographic image is implemented by at least one holographic optical element.

Thus, the light emanating from the light source may be incident on a light entrance region. By preference, the light entrance region denotes a region on the substrate where the light enters the substrate. The light reemerges at a light exit region for the purpose of generating the holographic image. In a manner analogous to the light entrance region, the light exit region denotes a region of the substrate where the light emerges for the purpose of generating a holographic image.

Within the meaning of the invention, a holographic optical element (abbreviated HOE) preferably denotes a component which was provided by holography methods and which fulfills an optical function. In preferred embodiments, the at least one holographic optical element is a hologram which realizes a specific optical function. Hence, the beam path of the light incident on the main body is influenced by the at least one holographic optical element. For example, an optical function can be a transmission, reflection, diffraction, scattering and/or deflection of light.

Advantageously, holographic optical elements can be produced cost effectively. Moreover, holographic optical elements are robust, have a low susceptibility to disturbances and are long-term stable. Furthermore, the at least one holographic optical element is distinguished in that it can be designed to be particularly flat and hence requires extremely little space.

The at least one holographic optical element is preferably designed to fulfill an optical function for a plurality of wavelengths. For this purpose, for example, multiple holograms, each of which e.g. diffracts light at one wavelength, and/or multiplex holograms, which diffract light at a plurality of wavelengths, can be arranged as hologram stacks.

By preference, the holographic image is generated in front of the main body. The phrase “in front of” preferably means the region comprising the interaction region. By preference, the sound transducers are present behind the substrate. The phrase “behind” preferably means positioning in a region where the sound transducers are situated. These regions can also be described by the terms “front region” and “back region” in the context of the invention. In particular, the interaction region is situated in front of the substrate. By preference, the front region and back region are separated from one another by the main body.

In preferred embodiments, the light source can be situated in front of the substrate such that the light emanating from the front region reaches onto or into the main body. If the light source is situated in front of the substrate, it may be preferable for the at least one holographic optical element to comprise a reflection hologram which reflects light rays incident from the front in order to generate a holographic image in a front region. It may likewise be preferable for the at least one holographic optical element to comprise a transmission hologram, with light rays from a spatial direction from the front initially passing through the transmission hologram without being diffracted. By preference, the light rays can be reflected in the substrate or at a further reflection hologram and will subsequently be incident on the transmission hologram from behind. Various combinations of reflection holograms and/or transmission holograms are conceivable and can be used in the construction according to the invention.

In preferred embodiments, the light source can be situated behind the substrate such that the light emanating from the back region reaches onto or into the main body. If the light source is positioned behind the main substrate, it may be preferable for the at least one holographic optical element to comprise a transmission hologram which transmits light rays incident from behind in order to generate a holographic image in a front region. It may likewise be preferable for the at least one holographic optical element to comprise a reflection hologram, with, by preference, light rays from a spatial direction from behind initially passing through the reflection hologram without being diffracted. The light can be reflected back in the substrate or by a further reflection hologram and subsequently be guided to the reflection hologram from a direction from the front. Various combinations of reflection holograms and/or transmission holograms are conceivable and can be used in the construction according to the invention.

Further, it may be preferable for the light source to be arranged such that light rays are emitted on an edge of the main substrate, in a manner corresponding to an edge-lit configuration. In the case of an edge-lit configuration, too, it may be preferable for use to be made of transmission holograms, reflection holograms or a combination of transmission holograms and reflection holograms.

Furthermore, the at least one holographic optical element may be connected to a surface of the substrate. For example, the connection can be made possible by adhesive bonding and/or lamination. Moreover, it is preferable for the at least one holographic optical element to be connected as a film to the substrate. For example, the film might also be connected to the substrate only in the region of a light entrance region and/or light exit region. In alternative embodiments, a connection between the at least one holographic optical element in the form of at least one film and the substrate may be formed substantially over the entire area.

In particular, at least one holographic optical element is configured to modify the beam path of the light, for example by diffraction, reflection, transmission and/or refraction. In preferred embodiments, the at least one holographic optical element comprises a hologram. Rather than by way of the geometric shape of a transmissive or reflective object, as in the case of lenses or mirrors for example, the at least one holographic optical element preferably modifies the light in the beam path by means of the information stored in the hologram, for example as a change in the refractive index. In this case, the employed holograms for the at least one holographic optical element are by preference not produced as images of real objects but preferably as a superposition of various plane or spherical light waves, the interference pattern of which brings about a desired optical effect.

By preference, the at least one holographic optical element comprises one or more holograms. In this case, each hologram is recorded with at least one defined wavelength. A holographic optical element may comprise a plurality of holograms, for example, which can be arranged one on top of another as a stack. For example, a holographic optical element can have a number, preferably a plurality, of monochromatic holograms. In an alternative, a holographic optical element can comprise at least one hologram which is recorded with at least two defined wavelengths. Preferably, such a hologram is recorded with three different wavelengths of a defined color space, for example is configured as an RGB hologram or a CMY hologram or as a hologram formed from a number of individual wavelengths of a different color space. In the examples mentioned, R stands for Red, G stands for Green, B stands for Blue, C stands for Cyan, M stands for Magenta, and Y stands for Yellow.

By preference, the at least one holographic optical element comprises a material selected from a group comprising photosensitive glasses, dichromated gelatins, photopolymers, polycarbonate and/or triacetate. In particular, these materials can be attached to a film and/or be formed or provided by the film itself.

The main body preferably comprises the substrate and the at least one holographic optical element. For example, the substrate can be a circular or a square wafer which may have a thickness in the centimeter, millimeter or submillimeter range. The at least one holographic optical element is preferably connected to a surface of the substrate, i.e. to a front side and/or back side, or embedded within the substrate. The front and back sides of the main body can be in the form of plane surfaces. In this regard, the main body can be in the form of a plane-parallel plate or wafer, for example. However, it is also possible for the front side and/or the back side to have a curved embodiment. The main body may comprise glass and/or plastic. Further, the main body can be in one piece or have a multilayered construction. The main body can likewise be transparent or partly transparent. In particular, the substrate may likewise have a transparent or partly transparent embodiment. By preference, the transparent or partly transparent main body and/or substrate may transmit light from the light source.

Within the meaning of the invention, a sound transducer preferably denotes an apparatus that converts an electrical signal into acoustic signals in particular. In particular, an acoustic signal denotes the controlled emission of sound waves. Hence, in the context according to the invention, the sound transducer serves as a sound source.

Within the meaning of the invention, a sound channel denotes an opening in the substrate in particular, such that sound can propagate in the direction of the holographic image in the interaction region. The sound channel or the opening preferably extends from a back side to a front side, in full or preferably over at least a length of more than 50%, 60%, 70%, 80%, 90% or more of the thickness of the substrate. The opening is characterized by the absence of the substrate material. The opening can be substantially filled with air. It may likewise be preferable to introduce a different medium—preferably a sound conducting medium—into the opening for the purpose of forming the sound channel.

Advantageously, a sound pressure, especially fluctuations in respect of the sound pressure, can be sensed in the interaction region, with the result that advantageously the holographic image is haptically perceivable. The haptic perception of the holographic image can be adapted, depending on application, by way of the arrangement, the number, the shape and/or the size of the openings.

Advantageously, the sound propagation for generating the haptic perception and the light propagation for generating the holographic image can be implemented along an optical or acoustic axis.

The prior art has not disclosed such an arrangement since optical components have a disadvantageous transmissivity in respect of sound, especially ultrasound. For example, glass and/or plastic as material for the substrate is substantially non-transparent to sound waves, whereby a compact arrangement of the sound transducers on the optical axis behind a substrate did not appear implementable without disadvantageous effects with regards to the haptic perception.

By contrast, the inventors recognized that a provision of sound channels in the substrate allows the sound, preferably ultrasound, to be guided advantageously non-distortedly through the same (optical) substrate for generating a holographic image.

In a further preferred embodiment, the system is characterized in that the system is designed to generate the holographic image by a transmission hologram and/or a reflection hologram.

The at least one holographic optical element preferably comprises a reflection hologram and/or transmission hologram to this end. By preference, the at least one holographic optical element fulfills an optical function, for example a transmission and/or a reflection. Advantageously, it is thus possible to enable a multiplicity of geometric arrangements of the components of light source, main body and sound transducer for the purpose of generating the holographic image and, in particular, also the haptic perception in the interaction region. Consequently, it is advantageously possible to also regulate the interaction region and optimize the latter depending on application and installation space. Thus, a user can advantageously be situated at a plurality of positions and simultaneously sense the holographic image optically and haptically.

The label of the type of hologram comprised by the at least one holographic optical element preferably provides an indication with regards to the fulfilled optical function and with regards to the arrangement of the system components for reconstructing the holograms.

Reflection holograms are reflective holograms which reflect the light incident from the light source and consequently act like a mirror. In the case of a reflection hologram, the light source can be situated in front of or behind the substrate. For example, it may be preferable for the light source to be situated in front of the substrate and direct its emission to the reflection hologram from this spatial direction from the front. Consequently, the light entrance region and the light exit region can be identical when a reflection hologram is used, i.e. the light rays are incident on the reflection hologram through the light entrance region, are reflected by said reflection hologram and reemerge from the same region in order to display the holographic image. It may likewise be preferable for the light source to be situated behind the substrate and initially direct its emission from this spatial direction through the reflection hologram without diffraction. The light can preferably be reflected in the substrate or by a further reflection hologram and subsequently be incident on the reflection hologram from a direction from the front.

For a defined wavelength, the reflection hologram advantageously accepts a broader angular spectrum with a high efficiency and a higher wavelength selectivity. As a result, the colors can be separated from one another despite a broad angle of incidence spectrum. In particular, it is possible to advantageously realize a large field of view for the holographic image with a high irradiation efficiency at the same time.

In some embodiments, it may be preferable to successively arrange two reflection holograms in the beam path, with the light source preferably being situated behind the substrate. The first reflection hologram allows the light waves from the light source to pass substantially without being diffracted to a second reflection hologram behind the first. The second reflection hologram reflects or diffracts the light rays back to the first reflection hologram. There is a reflection or diffraction at the first reflection hologram for the purpose of generating a holographic image in front of the substrate. Consequently, reflection holograms arranged thus enable a construction analogous to a transmission hologram, with it however being possible to exploit the above-described advantages of reflection holograms.

The light from the light source is let through in the case of a transmission hologram. When a transmission hologram is used, it is preferable for the light source to be situated in front of or behind the substrate. For example, it may be preferable for the light source to be situated behind the substrate and direct its emission to the transmission hologram, which diffracts the light rays, from this spatial direction from behind. In this case, the light entrance region and the light exit region are situated on different sides of the substrate in particular. It may likewise be preferable for the light source to be situated in front of the substrate and initially direct its emission from this spatial direction through the transmission hologram without diffraction. By preference, the light can be reflected in the substrate and subsequently be incident on the transmission hologram from a direction from behind and be diffracted by said transmission hologram, with the result that a holographic image is generated in a front region. Preference may be given to transmission holograms in order to avoid color distortions. Moreover, the holographic image from a transmission hologram advantageously has a large depth of field, i.e. a particularly extended region that can be identified in focus by an observer.

In further preferred embodiments, the system is designed to generate the holographic image by an edge-lit configuration. By preference, an edge-lit configuration denotes the radiation of the light onto an edge or peripheral region of the substrate and an emission of the light for generating a holographic image in a front region. In the case of an edge-lit configuration, the at least one holographic optical element can preferably be embedded on the substrate or within the substrate for this purpose. Further, the at least one holographic optical element can be a reflection hologram and/or transmission hologram even in the case of an edge-lit configuration. By preference, the substrate is designed as a light guide when an edge-lit configuration is used. As a result, the illumination of the light source can cause the light to propagate within or through the substrate by reflections, preferably by total-internal reflection, and the holographic image can be displayed in the interaction region.

The circumstance that the light source can be integrated into the main body and/or the substrate itself when an edge-lit configuration is used is particularly advantageous, whereby a particularly compact and carefully aligned display of the holographic image is ensured. In particular, the holographic image can appear particularly clearly, with the result that an observer experiences a particularly realistic image of an object. It may be preferable to use reflection holograms for this purpose as these can be used to particularly optimize brightness and sharpness of contour for a realistic display.

An edge of the substrate preferably denotes a lateral region of the substrate which has a thickness that is significantly less than the length and/or width of the substrate. For example, the thickness of the edge can be approx. 0.2 mm, approx. 0.5 mm, approx. 1 mm, 5 mm, 10 mm or 50 mm. In this case, it is preferable for a ratio of the thickness of the edge to the length and/or width of the substrate to be more than 1:10, more than 1:50 or more than 1:100. In the context according to the invention, the terms periphery and edge of the substrate can be used synonymously.

In a further preferred embodiment, the system is characterized in that the substrate comprises an input coupling region and an output coupling region situated at different positions on the substrate, and the light propagates within the substrate between the input coupling region and the output coupling region by way of reflections, preferably by total-internal reflection.

Consequently, the substrate can advantageously also act as a light guide, within which the light is able to propagate, in order to provide the holographic image in the interaction region. In this context, the terms “input coupling region” and “output coupling region” are intended to describe an entrance portion and an exit portion of the substrate if the substrate itself is designed as a light guide.

In this context, the input coupling region preferably denotes a region of the substrate which allows light to penetrate into the substrate such that the light is input coupled within the substrate. By preference, the input coupling region may comprise a holographic optical element used to input couple the light into the substrate.

The input coupling region may also have a transparent or partly transparent configuration in some embodiments. In the case of a desired transparency, the input coupling of radiation by means of e.g. a diffractive structure may be precisely so efficient that a sufficient radiation power is incident on the output coupling region. The partly transparent input coupling region can be embodied such that the input coupling efficiency is e.g. 2%, 5%, 10%, 15%, 20%, 25%, 30%, 35%, 40%, 45% or 50% or more. In this case, the input coupling efficiency denotes the proportion of light which can be transmitted and hence introduced into the substrate.

In particular, input coupling the light within the substrate denotes the entrance and the propagation of light therein. The propagation of light within the substrate is preferably implemented by reflections, particularly preferably by total-internal reflection. The total-internal reflection in particular leads to the light not being emitted uncontrollably from the region but being steered in the direction of the output coupling region in a targeted manner in order to display the holographic image in or from the region of the output coupling region.

The principle of total-internal reflection can be illustrated by the incidence of light at an interface at the transition of two media. If a light beam passes from one medium to a second medium of different optical density, then two phenomena may occur at the interface, specifically that some of the light is refracted and enters into the second medium or some of the light is reflected and remains in the first medium. If the first medium is optically denser than the second medium, then the refracted beam runs parallel to the interface above a certain angle of incidence. If the angle of incidence is increased further, no light penetrates into the second medium any longer, and the light beam is reflected in full. The latter is referred to as total-internal reflection. In the context according to the invention, the expression “total-internal reflection” means total-internal reflection within the substrate, with the substrate preferably acting as a light guide.

Total-internal reflection may occur at the front side, at the back side and within the substrate. It is also possible that reflective layers or coatings or partly reflective layers or coatings are provided for the propagation of the light within the substrate by reflections, preferably by total-internal reflection.

By preference, the propagation of the light along or within the substrate can also be implemented with the aid of an edge-lit configuration. By preference, the light in this context is let in at one edge of the substrate and propagates within the substrate, preferably to the at least one holographic optical element which may be a reflection hologram, for example. As a result of the effect of the HOE, the light preferably emerges in the output coupling region in order to display the holographic image, preferably within the interaction region.

By preference, the output coupling region denotes the region of the substrate as a light guide, from which the light is output coupled in order to image the holographic image in the interaction region. By preference, the output coupling region may comprise a holographic optical element used to output couple the light from the substrate.

In a manner analogous to the input coupling region, the output coupling region can have a transparent or partly transparent form in some embodiments. In particular, the output coupling efficiency of the output coupling region can be e.g. 2%, 5%, 10%, 15%, 20%, 25%, 30%, 35%, 40%, 45% or 50% or more. In this case, the output coupling efficiency denotes the percentage of light which can be transmitted and hence let out of the substrate.

In a further preferred embodiment, the system is characterized in that the input coupling region is situated at a periphery of the substrate and/or the input coupling region comprises a first holographic optical element, with the light being input-couplable into the substrate and deflectable within the substrate by the first holographic optical element.

Advantageously, the light beam path within the substrate can be set precisely by the first holographic optical element with an appropriate optical function, for the purpose of allowing the light to propagate within the substrate. The first holographic optical element can be present on a front side, on a back side, on an edge and/or within the substrate.

By preference, the first holographic optical element is in the form of a reflection or transmission hologram. It is also preferable for the first holographic optical element to be a reflection or transmission hologram if input coupling of the light is implemented by way of an edge-lit configuration.

In further embodiments, the input coupling region may comprise a diffractive structure which is formed on a front and/or back side of the substrate. For example, the diffractive structure of the input coupling region can be in the form of a buried diffractive structure or a diffractive structure on the front side or back side of the substrate. It is likewise possible for the diffractive structure of the input coupling region to comprise a transmissive or reflective relief grating.

In a further preferred embodiment, the system is characterized in that the output coupling region comprises a second holographic optical element, and light for generating the holographic image in the interaction region exits through the output coupling region.

Advantageously, the light is output coupled in a targeted manner by the second holographic optical element, with the result that the holographic image can be generated at desired positions within the interaction region. In further embodiments, the second holographic optical element can be in the form of a reflection or transmission hologram. Advantageously, the light is reflected or transmitted into the interaction region in such a way that the holographic image appears within the interaction region.

The output coupling region comprises a diffractive structure in further embodiments. The diffractive structure of the output coupling region can be in the form of a buried diffractive structure or a diffractive structure on the front side or back side of the substrate. In particular, a reflection or transmission hologram can be provided as diffractive structure. It is further possible for the diffractive structure of the output coupling region to be a transmissive or reflective relief grating. The output coupling region may likewise comprise a mirror surface, a prism and/or a reflective or transmissive Fresnel structure. These variants can be provided as an alternative to the diffractive structure or in addition to the diffractive structure of the output coupling region.

By preference, a diffractive structure denotes an optical element for shaping the light beam emanating from the light source. By preference, the diffractive structure comprises microstructures, which are applied by photolithography for example. Phase modulations occur in the microstructures on account of different optical path lengths of the component beams, whereby interference patterns arise. Additionally, the amplitude is modulated by constructive and destructive interference. Thus, skillful design allows the intensity patterns and/or the path of the beam to be manipulated in order to generate the holographic image.

In a further preferred embodiment, the system is characterized in that the system comprises 2, 3, 5, 10, 20, 50, 100 or more sound transducers, with the sound transducers preferably being arranged as an array.

The sound transducers are preferably configured to emit sound waves in the direction of the holographic image. In particular, the sound transducers are situated “behind the substrate” in this case, i.e. the substrate is arranged between the interaction region and the sound transducers.

Advantageously, an acoustic field can be generated within the interaction region by a plurality of sound transducers, in particular by an array. In this context, the acoustic field is distinguished by a pressure and/or intensity distribution preferably allowing the provision of a different haptic perception on the human skin for different regions of the holographic image. In particular, a varying force acts on the skin and haptically reproduces the shape and/or structure of an object visualized by the holographic image. For example, a joystick and/or a keyboard of an automobile can be represented as a holographic image. The region of the joystick which is touched and/or the keys of the keyboard may have a different pressure and/or force sensation than other portions of these objects.

By preference, a sound transducer or a plurality of sound transducers are connected to one or more phase control components. Advantageously, the phase of the sound waves emitted by the sound transducers can be subject to open-loop and/or closed-loop control by the phase control component. What is particularly advantageous here is that it is possible to set the phase such that the pressure is maximized and/or minimized in certain regions of the holographic image and/or interaction region, with the result that a particularly realistic haptic perception of the holographic image is generated.

In further embodiments of the invention, the sound transducers generate a predetermined distribution of pressure patterns, with the result that a first haptic sensation of the holographic image is provided in one portion of the interaction region and a second haptic perception of the holographic image is provided in a further portion of the interaction region.

By providing different haptic sensations, the system according to the invention allows the user to bring e.g. their hand precisely into the correct position in order to identify and/or implement shapes, structures and/or inputs. Furthermore, the system can be configured to provide the user with haptic feedback, for example when the hands of the user are in the correct position for the interaction with the holographic image. For example, a vibration can be transmitted if the finger of the user is situated in the region of a play and/or pause controller or volume controller of a keyboard as holographic image. Alternatively, it is also possible to increase the perceived strength or intensity of the feedback. There can also be haptic feedback once control gestures have finished, for example. In particular, the system can be configured such that gestures and/or controls of a user on, in and/or along the holographic image can be registered.

The sound transducers are preferably arranged as an array. Within the meaning of the invention, an array denotes a geometric configuration with regards to the arrangement, i.e. positioning, of the sound transducers. For example, the sound transducers can be arranged in a one-dimensional, two-dimensional or three-dimensional fashion. By preference, the sound transducers are arranged as a grid and/or have a fixed distance from one another. For example, the sound transducers may have a distance from one another of up to approx. 250 mm, approx. 200 mm, approx. 150 mm, approx. 100 mm, approx. 50 mm, approx. 20 mm, approx. 10 mm, approx. 5 mm, approx. 2 mm or approx. 1 mm.

In further embodiments, it may be preferable for beam forming technology to be used for the sound propagation. As a result, control of the phase control components allows sound waves to be directionally emitted by way of interferences, for example in order to obtain a specific pressure increase in certain regions.

By preference, the system according to the invention comprises a control unit configured for closed-loop control of the phase, the intensity, the intensity distribution, the pressure and/or the frequency of the sound transducers. Advantageously, the sound transducers can emit over an angular range along a plane of up to 180°, preferably up to 120°, particularly preferably up to 80°, very particularly preferably up to 50°, even more preferably up to 30° and very much preferably up to 10°, with the result that sound waves can be emitted in particularly focused fashion.

Advantageously, the sound waves can pass through the substrate by way of the sound channels in a manner largely free from distortions, with the result that a user experiences a particularly realistic haptic perception of the holographic image. For example, a desired pressure of 10-50 Pa (pascal) can be enabled over an angular range of approx. 40-70° at a distance of approx. 10-40 cm. The parameter settings of the sound can preferably be set and/or controlled by the control unit.

By preference, the system also comprises a controller for controlling the components of the system, for example ultrasound transducers or the light source.

Within the meaning of the invention, a control unit preferably denotes a computing unit such as a processor, a processor chip, a microprocessor and/or a microcontroller for automatically controlling the components of the system, for example the ultrasound transducers, by specifying parameters of the sound waves (e.g. phase, intensity, pressure, frequency, etc.). In further preferred embodiments, the control unit can be a computing machine such as e.g. a computer, a computer device or a computer system. The components of the controller can be configured conventionally or individually for the respective implementation. By preference, the controller comprises a processor, a memory and a computer code (software/firmware) for controlling the components of the apparatus.

By preference, the control unit can preferably also be a programmable circuit board, a microcontroller or any other component for receiving and processing data signals from the components of the system, in particular the sound transducers or the light source. By preference, the control unit also comprises a computer-usable or computer-readable medium, for example a hard disk drive, a random access memory (RAM), a read only memory (ROM), a flash memory, etc., on which computer software or a code is preferably installed. The computer code or the software for controlling the components of the system according to the invention can be written in any desired programming language or model-based development environment, for example in C/C++, C#, Objective-C, Java, Basic/VisualBasic, MATLAB, Simulink, StateFlow, Lab View or assembler.

The phrase the controller is configured to carry out a specific work step, for example a control of the phase, the intensity distribution, the pressure and/or the frequency of the sound transducers, may comprise customer-specific or standard software which is installed on the controller and which initiates and controls these operational steps.

In a further preferred embodiment, the system is characterized in that the sound transducers are ultrasound transducers configured for a sound emission in a frequency range from 20 kHz to 100 kHz, preferably 30 kHz to 60 KHz.

A particularly efficient haptic perception may advantageously result from the use of ultrasound transducers. Further, ultrasound transducers have proven their worth in the technical field of haptic or tactile sensation projection, for the purpose of optimally and easily generating haptic feedback. In this context, an ultrasound transducer denotes a sound transducer which emits ultrasound, especially in the appropriate frequency ranges.

In a further preferred embodiment, the system is characterized in that the pressure fluctuations are generated by acoustic sound waves with a carrier frequency and a modulation frequency, with the carrier frequency preferably being between 20 kHz (kilohertz) and 100 kHz and/or the modulation frequency lying in a range between 0.1 Hz (hertz) and 500 Hz, particularly preferably in a range between 150 Hz and 250 Hz. By preference, this can be controlled by a control unit.

The modulation of the acoustic waves with a frequency of between 0.1 Hz and 500 Hz advantageously leads to a user being able to haptically perceive the holographic image particularly well. In particular, this is due to the fact that the mechanoreceptors of the human skin are particularly sensitive to these frequencies. Thus, the holographic image can advantageously be combined with a particularly realistic haptic perception.

In further embodiments, the sound transducers can emit sound in such a way that control points are defined within the interaction region. By preference, a control point denotes a marking at a specific location within the interaction region. Control points can be distinguished by regions which are assigned a specific amplitude and/or a specific phase. Thus, a control point can also be modeled such that a sound transducer is situated directly below the control point. By preference, the spacing between the control points is such that it substantially corresponds to a wavelength of the sound. A control unit is preferably configured to define such control points within the interaction region. Advantageously, shapes and/or portions of the holographic image can be defined by control points. For example, a volume comprising a multiplicity of edges and/or corners can be modeled by the control points, with the result that the control points are present at the edges and/or corners and a defined pressure is perceived as a result. The control points can also define a shape which can be felt as part of a haptic feedback system by a user. By preference, the user can perform an interaction in the region that can be felt.

In a further preferred embodiment, the system is characterized in that the light source is situated within or outside of the substrate, with the light source by preference being a laser and/or an LED.

In particular, attaching a light source within the substrate advantageously leads to the system according to the invention being configured particularly compactly. As a result of a compact configuration, the system according to the invention can be integrated in a multiplicity of application possibilities. An attachment of the light source outside of the substrate is advantageous to the effect of achieving more variability and flexibility with regards to the type of light source and the irradiation and/or radiation of the main body and/or substrate. For example, this lessens the requirements with regards to compact dimensioning of the light source and moreover allows the latter to be attached to different positions if an adapted incoming radiation angle is desired in the direction of the main body and/or substrate.

It is also preferable for the at least one holographic optical element to be introduced as a volume hologram on a front side, on a back side and/or within the substrate. By preference, a volume hologram denotes a hologram which was written in a light-sensitive, comparatively thick layer. By preference, this can be implemented by transmission or reflection technology. A sequence of Bragg planes advantageously arises as a result of the interference of object and reference beam within the hologram volume. A volume hologram can therefore also be considered to be a holographic grating, i.e. an optical grating produced by holography methods. Consequently, a volume hologram preferably has a non-negligible extent in the propagation direction of the light beams, with the Bragg condition applying in the case of a reconstruction at a volume hologram.

It is for this reason that volume holograms have a wavelength and/or angle selectivity. The capability of volume holograms to store a plurality of images at the same time inter alia allows the production of colored holograms. Light sources emitting in the three primary colors of blue, green and red can be used for the recording of the holograms. Following the exposure, three holograms are stored in the volume hologram at the same time. The reproduction of the color hologram can exploit the fact that each partial hologram can only be reconstructed by the color with which it was recorded. Consequently, the three reconstructed color excerpts superimpose to form the colored, faithful image provided the color components are weighted correctly.

Moreover, volume holograms can advantageously deflect a particularly large variety of light rays particularly precisely in the direction of an exit or output coupling region within the interaction region and/or also deflect said light rays within the substrate in embodiments where the substrate acts as a light guide.

In preferred embodiments, the light source is coherent, particularly preferably partly coherent. A coherent light source is distinguished by the emission of coherent light beams. Coherence preferably refers to the property of optical waves according to which there is a fixed phase relationship between two wave trains. As a result of the fixed phase relationship between the two wave trains, spatially stable interference patterns can arise. In terms of coherence, a distinction can be made between temporal and spatial coherence. Spatial coherence preferably represents a measure for a fixed phase relationship between wave trains perpendicular to the propagation direction and is given, for example, for parallel light beams. Temporal coherence preferably represents a fixed phase relationship between wave trains along the direction of propagation and is given in particular for narrowband, preferably monochromatic light beams.

The coherence length preferably denotes a maximum path length difference or time-of-flight difference that two light beams from a starting point have, so that a (spatially and temporally) stable interference pattern arises during their superposition. The coherence time preferably refers to the time that the light needs to travel a coherence length.

In preferred embodiments, the light source is a laser. Particularly preferably, this is a narrow-band, preferably monochromatic laser with a preferred wavelength in the visible range (preferably 400 nm to 780 nm). Non-exhaustive examples include solid-state lasers, preferably semiconductor lasers or laser diodes, gas lasers or dye lasers.

Other light sources, preferably coherent light sources, may also be used by preference. Preferred are narrow-band light sources, preferably monochromatic light sources, including, for example, light-emitting diodes (LEDs), optionally in combination with monochromators.

In particular, the use of LEDs is advantageous to the effect that these are particularly compact and can be integrated particularly cost-effectively and particularly easily in the system according to the invention.

In a further preferred embodiment, the system is characterized in that the one or more sound channels are formed as openings within the substrate.

Advantageously, the light can be transported in a targeted manner in or through the substrate in order to generate the holographic image in the interaction region, and sound can likewise be passed through the substrate via the openings. In particular, the holographic image can be configured to be haptically perceivable in particularly efficient fashion. Consequently, perforated substrates can be used to generate holographic images and can be combined with sound transducers in order to obtain haptic feedback.

In this case, what needs to be considered in respect of the distance of the sound transducers and the holographic image is that the sound intensity reduces with the square of the distance.

Therefore, the sound transducers are preferably arranged such that pressure fluctuations that can be sensed by the human skin reach the interaction region through the openings. In this context, it may be preferable for the sound channels to be arranged directly next to and/or around the second holographic optical element.

An adapted positioning of the sound channels, in particular in the form of openings in the substrate, advantageously allows the generation of sound pressure patterns which serve the purpose of being perceived as a haptic signal. The sound pressure pattern may be distinguished by portions within the interaction region that have pressure maxima and/or pressure minima, said portions being situated along the holographic image in particular. In particular, constructive and/or destructive interference allows the pressure fluctuations to be effective at desired points and onward propagating wave fronts of the sound waves can cancel one another out. For instance, it may be preferable that the outwardly propagating wavefronts interfere destructively in a far region and interfere constructively in a near region, especially within the interaction region.

Advantageously, defined pressure field increases for the pressure pattern may be obtained in the interaction region, especially depending on the power of the sound transducers. In particular, it is thus possible to generate different sound pressures in very localized fashion and in a manner suitable for a perception as haptic signal.

In a further preferred embodiment, the system is characterized in that the one or more sound channels have an elliptical and/or a quadrilateral cross section.

Advantageously, influence can be exerted on the propagation of the sound waves and/or light by way of the geometric configuration of the sound channels.

Thus, an elliptical cross section of the sound channels is advantageous in that the modes of the sound are only influenced slightly. In particular, the mode spectrum of the sound is not modified or only modified to a very minor extent. By preference, sound channels which have an elliptical cross section are able to control the passage of the sound particularly well and easily. In this case, it was identified that the mode spectrum obtained becomes larger as the cross section of a sound channel becomes rounder. In particular, an elliptical cross section also comprises a circular shape of the sound channel. Consequently, elliptical cross sections of the sound channels are particularly advantageous for the propagation of sound through the substrate.

However, with regards to the light rays passing through the sound channels, an elliptical cross section of the latter may lead to these light rays being refracted. In particular, the light rays may be scattered outwardly, with outwardly preferably denoting a beam path away from the center of the light beam. Thus, an elliptical cross section of the sound channels may act like a diverging lens in relation to light passing the sound channel in the substrate.

To compensate the effect of the sound channel, it may be preferable to introduce a lens and/or a holographic optical element with a corresponding optical function, e.g. a lens function, which is advantageously able to re-focus the outwardly scattered light such that the light is aligned in a targeted fashion for the purpose of generating the holographic image. In preferred embodiments, a holographic optical element with a function of a converging lens is used to compensate for sound channels with an elliptical cross section. In this case, the lens or the holographic optical element with the function of a converging lens may have an inverse optical function to the curved sound channels. Advantageously, the light can be let through over a multiplicity of incoming radiation angles and/or colors can be merged correctly.

By contrast, a quadrilateral cross section for the sound channels was found to be particularly advantageous for the passage of the light rays in the substrate since the light is not refracted or only hardly refracted at the surfaces of the quadrilateral-in the case of an appropriate alignment. Particular preference is given to using a gap as a sound channel. By preference, a gap refers to a rectangular cross section with a significantly smaller width in the direction of the light propagation than in an orthogonal direction (length) thereto. For example, a gap can be narrower than it is long by a factor of 3, 5, 10 or more. In particular, a quadrilateral cross section comprises a rectangle, a square, a trapezoid, a parallelogram and/or a rhombus. In further embodiments, the cross section may also have digon-type, triangular, pentagonal, hexagonal, heptagonal, octagonal shape or any other polygonal shape. This does not restrict the geometric shape of the sound channels, especially as openings on the substrate. A polygonal cross section is advantageous to the effect of it being easier to provide a substantially orthogonal interface on which the light can be incident substantially perpendicularly, whereby aberrations can advantageously be minimized.

In a further preferred embodiment, the system is characterized in that the one or more sound channels have an angle of inclination within the substrate, and so this makes it possible to focus the sound waves on the holographic image.

A sound channel preferably has an angle of inclination if a straight line applied to a point on an edge of the sound channel has a different profile to that of the longitudinal and/or transverse axis of the substrate. In the context of the invention, this may also be referred to as a tilt.

Advantageously, a tilt of the sound channels leads to the possibility of obtaining an increased sound pressure within the interaction region. In particular, the holographic image can be perceived haptically with an increased intensity. It is particularly preferable for the sound transducers to also be present in tilted fashion. In this case, the sound pressure and hence the intensity can be intensified to a particularly great extent, and the haptic perception can be generated in particularly detailed fashion. Particular preference is given to the sound transducers having substantially the same angle of inclination as the tilted sound channels.

In a further preferred embodiment, the system is characterized in that the one or more sound channels partially or fully surround a light exit region or output coupling region within the substrate. Surround preferably means that the one or more sound channels are arranged on a contour which encloses the light exit region or an output coupling region, with one or more sound channels not being arranged in the light exit region or output coupling region itself.

Advantageously, a positioning of the sound channels along an outer contour of the light exit region or output coupling region may lead to a particularly efficient provision of pressure fluctuations within the interaction region for the purpose of generating a haptic signal. In particular, sound waves can advantageously be emitted in particularly focused fashion in the direction of the holographic image, with the result that particularly fine pressure fluctuations and hence a realistic haptic perception is generated. Advantageously, the holographic image can for example also be related to pressure fluctuations particularly faithfully in relation to shape, contours, sizes, etc.

In a further preferred embodiment, the system is characterized in that one or more sound channels, as openings within the substrate, are filled with a material, preferably a fluid, particularly preferably water, glycerin, an oil, preferably a silicone oil, with the material preferably having an optical refractive index substantially corresponding to a refractive index of the substrate.

Terms such as substantially, approximately, about, approx., etc. preferably describe a tolerance range of less than ±20%, preferably less than ±10%, particularly preferably less than ±5%, and in particular less than ±1% and always include the exact value. Preferably, similar describes values that are approximately the same. Partly preferably describes at least 5%, particularly preferably at least 10%, and in particular at least 20% or at least 40%.

Advantageously, filling a material which has a refractive index similar to that of the substrate material into the sound channels leads to the light rays experiencing less refraction. As a result, there is no need for a subsequent compensation or collimation, or the latter is simplified. The smaller the difference between the refractive indices of the material filled into the sound channels and the substrate material, the smaller the angular changes experienced by the light ray, and so a possible collimation can be implemented without errors. Consequently, the light can advantageously be steered without aberrations in the direction of the light exit or light output coupling region for the purpose of displaying the holographic image.

Oil, preferably optical oil, was found to be a particularly preferred material for filling the sound channels. In preferred embodiments, the substrate comprises a glass, in particular an optical glass or optical plastic with a refractive index of between 1.4 and 1.6, preferably of approx. 1.5. Advantageously, it is possible to choose oils, in particular optical oils, with a similar refractive index between approx. 1.4 and approx. 1.6, preferably of approx. 1.5, and so unwanted refractive effects can be minimized. Moreover, oils are distinguished by good conduction of sound, and so the sound waves also propagate largely without distortion or attenuation in the direction of the holographic image through an oil-filled sound channel.

In preferred embodiments, the material for filling the one or more sound channels is a fluid with an elevated surface tension, preferably with a surface tension at room temperature (20° C.) of at least 20 mN/m (milli-newton per meter), preferably at least 30 mN/m, 40 mN/m, 50 mN/m, 60 mN/m or more. The elevated surface tension of the fluid material minimizes the risk of the material flowing out of one or more sound channels. For the purpose of filling the one or more sound channels, a person skilled in the art can choose materials with preferred surface tensions depending on the geometric configuration of the sound channels (in particular a cross section of the sound channels) on the basis of known physical laws in order to ensure that the fluid reliably remains within the sound channels.

In a further preferred embodiment, the system is characterized in that one or more sound channels, as openings within the substrate, are filled with a material, preferably a fluid, with a membrane or a film being present in applied fashion on the substrate, at least over the region of the one or more filled sound channels. The fluid can preferably be one of the aforementioned preferred fluids which have an optical refractive index substantially corresponding to a refractive index of the substrate. However, the fluid can also be air, with the membrane or the film in that case essentially having a protective function against contamination.

By preference, the film or the membrane is applied on both sides to the surfaces of the substrate in order to close off the one or more filled sound channels on both sides. This advantageously enables a particularly reliable seal of a fluid material, independently of the surface tension or geometric configuration of the sound channels.

By preference, the film or the membrane is transparent to the light from the light source. Further, it is preferable for the film or the membrane to have a similar refractive index to the material of the substrate and/or the material for filling the sound channel. By preference, the membrane or film is impermeable for the enclosed fluid material. In preferred embodiments, the layer thickness of the film or membrane is less than 1 mm, preferably less than 500 μm, 400 μm, 300 μm, 200 μm or less. The membrane or the film is preferably able to vibrate.

For example, the membrane can be a silicone membrane and the film can for example be a transparent plastic film, e.g. a PMMA film (polymethylmethacrylate film). The membrane or film can be present on the substrate surface in attached fashion by way of an optical adhesive or an additional OCA film (OCA is the abbreviation for the expression optical clear adhesive), preferably at least in the region of the sound channels. By preference, an optical adhesive or an OCA film has a similar refractive index to the membrane, the film or the material of the substrate in order to ensure a smooth optical composite. By preference, the membrane or the film encloses the fluid in the one or more sound channels with as few bubbles as possible. Hence, there are preferably no air inclusions in the sound channel in order to advantageously ensure a substantially aberration-free passage of the light through the filled sound channel.

In preferred embodiments, a film lid is applied to the membrane or film. By preference, the film lid is distinguished by a greater mechanical stability than the film or the membrane. For example, it may be preferable for the film lid to have a layer thickness that is greater than the film or membrane by a factor of 2, 3, 4, 5, 10 or more. By preference the film lid serves to cover and protect the membrane or film. By preference, the film lid has openings or holes in the region of the sound channels, the number, shape and size of said openings or holes preferably corresponding to the number, shape and size of the sound channels. The film lid can preferably comprise the same material as the substrate, e.g. an optical plastic (e.g. PMMA) or an optical glass.

In preferred embodiments, a number or plurality of sound channels comprise the material, which has a similar refractive index to the substrate material. In further preferred embodiments, all sound channels are filled with the material. In particularly preferred embodiments, the sound channels arranged along or around a light exit or output coupling region are filled with the material. It may also be preferable to only fill the sound channels situated in the beam path of the light with a material, preferably a fluid, particularly preferably water, glycerin, an oil, preferably a silicone oil. In a preferred embodiment, the system is characterized in that one or more sound channels are sealed by a membrane or film. Air or, as explained above, a fluid whose refractive index is adapted to a refractive index of the substrate can preferably be present within the sound channel. By providing a membrane or film, it is possible to advantageously reliably avoid an ingress of dirt into the sound channels without impairing the sound propagation. There is no need to clean the sound channels.

Should no membrane or film be provided for the purpose of closing off the sound channels, cleaning of the sound channels on a regular basis may also be preferable. To facilitate cleaning of the sound channel, it is possible to carry out an optimization of the shape, in particular the dimensions, of the sound channel. It may also be preferable for cleaning to be implemented by means of the sound transducers themselves. For example, one or more sound transducers can be designed to emit sound waves that serve to remove dirt from within a sound channel. In particular, it is possible to emit sound waves which have a sound pressure level that is higher than an average value for generating a haptic perception, for example higher by a factor of 1.5, 2, 3, 5, 10 or more.

It may likewise be preferable to have a pulsed application of sound waves in the sense of “blowing-free” the sound channels for the purpose of removing possible contamination. Thus, especially by way of an appropriate configuration in a control unit, one or more sound transducers may be designed to emit stronger sound waves or ultrasound pulses within predetermined time periods for the purpose of removing possible contamination from the sound channels. Such cleaning can preferably be implemented at regular time intervals or depending on a degree of dirtying, wherein it may also be preferable to select possibly contaminated sound channels in a targeted manner and to clean these.

In a further preferred embodiment, the system is characterized in that the substrate comprises one or more holographic optical elements in front of and/or behind one or more sound channels, which are configured for a compensation, a deflection and/or an expansion of the light experienced by the light on account of a propagation through the one or more sound channels. In this context, in front of or behind preferably means upstream or downstream in relation to the light propagation direction in the substrate.

It is consequently advantageously possible to steer light beams in the direction of the light exit region or output coupling region in a targeted manner for the purpose of generating the holographic image in the interaction region, and/or the path of the beam can be configured to be particularly simple. In preferred embodiments, the second holographic optical element is situated at the light exit region or at the output coupling region. It may therefore be preferable for the light to be steered in the direction of the second holographic optical element before the light is emitted into the interaction region for the purpose of generating the holographic image.

Unwanted refractive effects of the sound channels on the light rays can preferably be compensated for by a holographic optical element for compensating light rays. For example, a compensation HOE can be configured to compensate a divergent effect of a sound channel by virtue of re-collimating the light rays. A correction of chromatic effects might also be preferable, by virtue of colors being merged correctly by holographic optical elements for compensation purposes. In this case, holographic optical elements for compensating the light, which are also referred to as compensation HOEs, can be embedded in front of a sound channel, behind a sound channel, in particular on a front and/or back side and/or within the substrate as well. A compensation HOE preferably has an optical inverse function to the sound channels which influence the propagation of the light rays in the substrate and which preferably serve for reducing aberrations.

In the case of an elliptical sound channel, the compensation function may for example consist in the form of a collimation such that an effect of the sound channel is compensated, i.e. offset.

In a preferred embodiment, the system may also comprise one or more holographic optical elements which are configured to deflect the light in such a way that the light rays are substantially steered around the sound channels. In the context of the invention, these HOEs are referred to as deflection HOEs. Advantageously, light rays and the sound channels do not come into contact with one another as a result of an appropriate deflection. In particular, there is no scattering and/or refraction as a result of the sound channel in that case, with the result that advantageously a particularly undistorted and faithful holographic image is generated.

In further preferred embodiments, the light can also be deflected in such a way that it is fanned open and steered in collimated fashion in the direction of the light exit region or output coupling region. Within the meaning of the invention, an expansion of light preferably means an increase in the optical beam diameter, i.e. the size of a light beam. In particular, the beam diameter relates to the diameter of any line running perpendicular to the beam axis and cutting the latter. Advantageously, an enlarged holographic image can be generated by an expansion of the light beams. For example, the light beams can be expanded by a holographic optical element whose effect is that of a diverging lens, i.e. which emits light over a broad area and, in particular, deflects the light in the direction of the light exit or output coupling region.

In further embodiments, a plurality of holographic optical elements can be used to expand the light. In the context of the invention, this may be referred to as pupil dilation. The term is inspired by human pupil dilation, for example if an increased amount of light should pass within the iris of the eye when in darkness in order to recognize objects. In the context of the invention, pupil dilation means an increase in the dimensions with which light is steered into the light exit region or output coupling region.

In a further preferred embodiment, the system is characterized in that the substrate comprises an input coupling region and an output coupling region, with the one or more sound channels at least partially surrounding the output coupling region and the light passing to the output coupling region of the substrate being steered past the sound channels by one or more holographic optical elements and/or the light passing to the output coupling region of the substrate being guided past sound channels by a light channel, with one or more holographic optical elements which expand the light and steer it in collimated fashion to the output coupling region preferably being present downstream of the sound channels.

The aforementioned options for attaching holographic optical elements for the compensation, deflection and/or expansion of light can in particular also be used if the substrate acts as a light guide. In the context according to the invention, the holographic optical elements which serve for the described optical functions can be referred to as compensation HOEs, deflection HOEs or expansion HOEs. In particular, it may be preferable to arrange a plurality of such holographic optical elements on and/or in the substrate. In preferred embodiments, the compensation HOE, deflection HOE or expansion HOE is selected from a group comprising one or more reflection holograms and/or transmission holograms.

Further, it is preferable for the substrate to be connected to a light channel and for the light source to irradiate the light channel and the light to be let into the substrate via the light channel. In particular, the light can subsequently be deflected in a targeted manner such that it need not propagate through the sound channels but can propagate around the sound channels. Light is preferably input coupled into the light channel such that it always undergoes total-internal reflection at the interface between an optically denser material (higher refractive index) of the light channel and an optically thinner material (lower refractive index) of the surroundings of the light channel.

Advantageously, the system according to the invention supplies numerous options for steering the light past the sound channels in particular and letting said light propagate into the exit or output coupling region for the purpose of displaying the holographic image. In particular, the holographic image being subject to aberrations as a result of the geometric configuration of the sound channels can be reliably prevented in this case without additional outlay (or compensation HOEs).

In a further preferred embodiment, the system is characterized in that the substrate comprises a material which is an optical plastic, preferably selected from a group comprising polymethylmethacrylate (PMMA), polycarbonate (PC), cycloolefin polymers (COP), cycloolefin copolymers (COC) and/or an optical glass, preferably selected from the group comprising borosilicate glass, B270, N-BK7, N-SF2, P-SF68, P-SK57Q1, P-SK58A and/or P-BK7.

These materials are distinguished by good optical properties for holography and are also suitable for industrial scale manufacturing. They are advantageously distinguished by cost-efficient series production with an unchanging, highest optical quality. Further, various geometric and complex geometries can be enabled, for example by further processing.

In a further aspect, the invention relates to a use of the system according to the invention for generating a haptic perception and a holographic image in an interaction region. Thus, the holographic image can advantageously be perceived particularly efficiently and optimally from a haptic point of view. In particular, pressure differences may correspond to the geometric design of the object intended to be represented by the holographic image, with the result that a particularly realistic impression arises for a user.

A person of average skill in the art recognizes that technical features, definitions and advantages of preferred embodiments described for the system according to the invention for generating a haptic perception and a holographic image equally apply to the use of the system for generating a haptic perception and a holographic image, and vice versa.

In particular, the system according to the invention can be used in numerous fields of application, especially in many modern technological applications.

For example, the system according to the invention can be advantageously used in the context of operating areas, for example holographic buttons. Within the meaning of the invention, a holographic button denotes a holographic image which is generated and able to interact with a user. The interaction of the user can relate to contact in particular. For example, contact can lead to a specific function being fulfilled. For example, it might be conceivable that the system according to the invention displays a keyboard and/or a joystick as holographic image. In this case, a user can operate the keyboard and/or the joystick by way of the holographic image, for example, without needing to touch the actual keyboard and/or the joystick in the process. This applies to any object that can be visualized by holographic imaging. This is particularly advantageous in terms of hygiene since the objects themselves need not be touched. This is relevant especially in the case of apparatuses usually used by many users, for example a gear selector of an automobile and/or a keyboard in an elevator, for example.

In a preferred embodiment, the system comprises a detector, wherein the detector is preferably designed to identify an operating gesture in relation to the holographic image. The detector preferably is a photodetector for detecting electromagnetic radiation, preferably visible light or infrared radiation. Non-limiting examples comprise digital image sensors, for example a CCD sensor or a CMOS sensor, or else photodiodes, photocells or phototransistors, wherein these can preferably be present arranged as an array.

While a holographic image and haptic perception is generatable in the interaction region in front of the main body, the arrangement of a detector preferably allows a detection of operating gestures performed in the interaction region. By preference, an operating gesture refers to a contactless interaction of a user in relation to the holographic image. For example, if a holographic button or a keyboard is generated in the interaction region, the operating gesture can be a tap, sweep or swipe input. For a holographic image in the form of a joystick, the operating gesture can likewise correspond to a movement of the joystick, for example.

Measured data acquired by the detector are preferably transmitted to a control or computing unit, which is configured to identify operating gestures. By preference, an appropriate computer code (software/firmware) can be present to this end, stored on the control or computing unit.

In preferred embodiments, the system is configured to adapt the display of a holographic image and/or tactile feedback depending on an identified operating gesture. For example, it may be preferable to identify the recognized actuation of a holographic button, either by changing the color and/or shape of the holographic button and/or haptically by way of a pressure fluctuation. Likewise, it may be preferable in relation to a joystick to update the haptic perception and/or holographic image of the joystick on the basis of a recognized operating gesture.

Consequently, this can provide a particularly user-friendly operating system which enables a very realistic interaction with holographic objects for the purpose of contactless operation.

Various arrangements of the detector are conceivable in relation to a positioning, with it being preferable for the detector to sense electromagnetic radiation from the interaction region. To this end, it is possible to provide optical components for steering, collimation and/or focusing, for example lenses, mirrors, diffractive structures or holographic optical elements.

In a preferred embodiment, the detector is present arranged behind the main body, and consequently on the opposite side to the interaction region. In this embodiment, the detector consequently is preferably on the same side of the main body as the sound transducers. As a result of an appropriate provision of optical components, e.g. lenses, one or more planes from the interaction region are preferably imaged on the detector, for example a CCD sensor or CMOS sensor, such that an operating gesture can be determined on the basis of the measured data. In this embodiment, it is preferable for the detector to be located on an optical axis with the holographic image or a holographic optical element for generating the holographic image.

To allow any desired position of the detector, it may be preferable to provide a second light guide or waveguide which serves for a light transmission in the direction of the detector. By preference, the second waveguide can be a functionalized waveguide as known from WO 2020/157306 A1, the content of which is incorporated in full herein by reference.

For example, the second waveguide may comprise a second main body with a front side and a back side, wherein the main body comprises a partly transparent second input coupling region and a second output coupling region spaced apart therefrom in a first direction. By preference, the second input coupling region can be located on an optical axis with the holographic image and may comprise a diffractive structure which deflects at least some of a radiation coming from an operating gesture to be detected in the interaction region, with the result that the deflected part, as input coupled radiation, propagates through the second main body as far as the second output coupling region by reflection. The deflected part of the input coupled radiation is preferably steered to the detector by the second output coupling region.

In this embodiment, the terms second input coupling region and second output coupling region denote a region for input and output coupling, respectively, a radiation relating to an operating gesture to be detected from the interaction region. Therefore, the second input coupling and output coupling regions can also be referred to as detection input coupling region and detection output coupling region for this embodiment. As a rule, the regions are not identical to the above-described (first) input and output coupling regions for generating a holographic image. It may likewise be preferable to call the second waveguide a detection waveguide. Embodiments described for the (first) main body especially with a substrate acting as a light guide preferably likewise apply to the second main body, which serves as a waveguide for a radiation to be detected.

For example, the transparent body can be in the form of a plane-parallel plate. The partly transparent main body can consist of glass and/or plastic. It can be in one piece or comprise a multilayered construction. In particular, the transparent main body can be transparent to radiation or light from the visible wavelength range (preferably 400 nm to 780 nm). Further, there may be transparency to the near infrared (780 nm to 3000 nm, preferably 780 nm to 1400 nm) and/or the entire infrared range (3000 nm to 1 mm, preferably 3000 nm to 50 μm).

The second input coupling region can likewise have a transparent or partly transparent configuration. In the case of a desired transparency, the input coupling of radiation by means of e.g. a diffractive structure may be precisely so efficient that a sufficient radiation power is incident on the output coupling region. The partly transparent second input coupling region can be embodied such that the input coupling efficiency is e.g. 2%, 5%, 10%, 15%, 20%, 25%, 30%, 35%, 40%, 45% or 50% or more. In this case, the input coupling efficiency denotes the proportion of detected radiation from the interaction region which can be transmitted and hence introduced into the substrate of the second main body.

The transparent or partly transparent second input coupling region is preferably embodied such that the deflection is without an imaging optical function (e.g. without a focusing effect). In particular, the reflections can be total-internal reflections at the front and/or back side of the transparent main body. However, it is also possible for reflective layers or coatings or partly reflective layers or coatings to be provided for this purpose.

The output coupling region of the transparent second main body can deflect at least some of the input coupled radiation incident thereon such that the deflected portion emerges from the second main body. This is preferably implemented in the direction of the detector via the front side or back side of the transparent second main body.

The second output coupling region can likewise be embodied as partly transparent. In particular, the output coupling efficiency of the second output coupling region can be e.g. 2%, 5%, 10%, 15%, 20%, 25%, 30%, 35%, 40%, 45% or 50%. In particular, the output coupling efficiency of the second output coupling region can be in the range of 2%-50%, and so the transparency of the second output coupling region is in the range of 50%-98%.

The partly transparent embodiment is advantageous, for example, if the second input coupling region and the second output coupling region are in the form of diffractive structures (e.g. volume holograms). In that case, the second input coupling region and the second output coupling region can be formed in e.g. a film, which is advantageous from the standpoint of production engineering. However, it is also possible that the second output coupling region has a maximum output coupling efficiency. For example, this can be realized by means of a reflective coating (preferably a reflective coating all over).

The second input coupling region and the second output coupling region can be embodied such that they do not bring about an optical imaging function besides the deflection. However, it is also possible for the second input coupling region and/or the second output coupling region to provide an optical imaging function in addition to the deflection and hence bring about an optical imaging. Thus, the optical imaging function can realize for example the function of a converging lens or diverging lens, a concave or convex mirror, wherein the curved surfaces can be (centered or off-centered) spherically curved or aspherically curved surfaces.

In preferred embodiments, the second output coupling region also comprises a diffractive structure. The diffractive structure of the second input coupling region or second output coupling region can be realized as a buried diffractive structure, as a diffractive structure between two substrates or as a diffractive structure embodied on the front or back side.

In particular, a reflection or transmission hologram can be provided as diffractive structure for the second input coupling or output coupling region. It is further possible for the diffractive structure of the second input coupling or output coupling region to be a transmissive or reflective relief grating. The second output coupling region may likewise comprise a mirror surface, a prism and/or a reflective or transmissive Fresnel structure. These variants can be provided in an alternative to the diffractive structure or in addition to the diffractive structure.

The second input coupling region is particularly preferably embodied as a reflective volume hologram which has an angle of incidence-dependent wavelength selectivity, and so it has a high transparency for a large angular and wavelength range.

This allows the provision of a detector system which enables an optical detection of operating gestures in the interaction region, advantageously without influencing the quality of the holographic image generated. Although the second input coupling region for the radiation to be detected is preferably located on an optical axis with the holographic image or a holographic element provided therefor in the (first) main body, it does not interfere with the holographic imaging.

To this end, it may be preferable for the wavelength of the radiation to be detected from an operating gesture in the interaction region and the wavelength of the radiation from the light source for generating a hologram to be different. For example, there may be a detection in the non-visible wavelength range (e.g. in the infrared range), while the holographic image is generated in the visible range.

The diffractive structures or holographic elements in the (first) main body (for generating the holographic image) or in the second main body (for detecting an operating gesture) can preferably be designed accordingly for different wavelengths. For example, a reflective volume hologram in the second main body can be designed to reflect infrared radiation for a radiation to be detected from the interaction region, while it transmits light for generating a holographic image in the visible range.

In a preferred embodiment, the system in combination with the detector comprises an IR radiation source (infrared radiation source), which is preferably designed to provide IR radiation in the interaction region. In particular, IR radiation relates to an infrared radiation in the range from 780 nm to 1 mm, preferably 780 nm-50 μm. Particularly preferably, the infrared radiation emitted by the IR radiation source is radiation in the near infrared range (780 nm-3 μm, preferably 780 nm-1400 nm).

In addition to the second waveguide for guiding a radiation to be detected from the interaction region to the detector, the (first) main body preferably also serves for generating a holographic image or its substrate also serves as a light guide, preferably as a guide for light in a visible wavelength range.

The second main body for the detection of an operating gesture can preferably be a component separate from the (first) main body for the generation of a holographic image. For example, the second main body for a detection can be present arranged in front of or behind the (first) main body for beam guidance for the holographic image. In this case, it may be preferable for the first and the second main body to be arranged at a distance from one another. Likewise, the first and the second main body may be present in interconnected fashion in order to realize a multilayered construction. By preference, a (first) main body guides the radiation from the light source for generating a holographic image (for example in the visible range) while the second main body guides the radiation which is guided from the interaction region to the detector (for example likewise in the visible range or in the infrared range) for the purpose of detecting an operating gesture.

Advantageously, in these embodiments, both the detector (for detecting an operating gesture) and the light source (for generating a holographic image) can be advantageously positioned flexibly depending on the installation space available. Corresponding first and second input coupling or output coupling regions can easily be provided in the first or second main body for this purpose.

The two main bodies themselves can form a compact unit, behind which the sound transducers are arranged, as described above. The embodiments are distinguished by a particularly compact configuration. In particular, the system can have an extremely shallow installation depth, with the result that hardly any installation space is required in this dimension. The introduction of the system is facilitated and numerous application options are generated.

To continue to ensure a reliable haptic perception within the interaction region, it is preferable for the second main body for the detection of an operating gesture to likewise comprise sound channels, with these sound channels preferably being arranged congruently with the sound channels which are situated in the substrate of the first main body for generating a holographic image. A person skilled in the art recognizes that preferred embodiments described in view of the configuration of sound channels in the substrate of the (first) main body likewise apply to the provision of sound channels in the second main body (or its substrate), which serves to guide a beam for the detection of an operating gesture.

In further embodiments, it may be preferable for the first and second main body to form a unit, i.e. to be preferably designed as a (single) main body which serves both as a waveguide for a radiation for generating the holographic image and as a waveguide for a radiation for detecting the operating gesture. In other words, it may be preferable for only a (first) main body with a (preferably monolithic) substrate to be provided, wherein both the radiation for generating the holographic image and the radiation for detecting the operating gesture are guided in the substrate, as described above. Consequently, such a main body will preferably comprise both first input coupling and output coupling regions for a radiation for generating a holographic image and second input coupling and output coupling regions for a radiation for detecting an operating gesture from the interaction region. Advantageously, the first and second input coupling and output coupling regions can be positioned independently of one another in the main body, depending on the requirements with regards to the positioning of the light source (for generating the hologram) or detector (for detecting an operating gesture). Rather than providing two main bodies or waveguides, the main body for the generation of the hologram advantageously acts as detection waveguide at the same time. Firstly, this can realize a particularly compact construction which enables an integration of the system with advantageously an extremely shallow installation depth. Secondly, interfaces between two main bodies are avoided in this embodiment, whereby a particularly high quality in relation to the holographic image and the detection of an operating gesture can continue to be obtained.

In preferred embodiments of the system, a plurality of input coupling portions can be provided in the second main body for the purpose of detecting an operating gesture, said input coupling portions steering a radiation of an operating gesture to be detected from the interaction region to a plurality of assigned output coupling portions. Accordingly, the second input coupling region and the second output coupling region preferably comprise an identical number of input coupling portions and output coupling portions, respectively, which may be present arranged in lines or a matrix for example. By preference, each output coupling portion may be assigned a sensor portion of the detector.

By preference, the detector is configured to continuously measure the intensity of the radiation incident on the respective input coupling portion and feed this to a controller. By preference, the controller is configured, on the basis of the measured intensity, to determine the distance of an input means for an operating gesture (for example a hand) in front of a respective input coupling portion. Ambient light can be used for the detection. A reduction in the measured intensity for an input coupling portion preferably indicates a shadowing of the input coupling portion by an input means (e.g. a finger of a hand) that has been brought closer. There can likewise be an active illumination of an input means in the interaction region, for example by way of a separate light source (e.g. by an LED frame). Such configurations of a preferred functionalized waveguide are disclosed in for example WO 2022/022904 A1, the content of which is incorporated in full herein by reference.

In WO 2022/022904 A1, the functionalized waveguide is used to provide a contactless area sensor, wherein in particular the intention is to enable a contactless input in a selection region in front of an optoelectronic display, such as an LCD element or an OLED element. According to the invention, it was recognized that the described detection principle for contactless determination of a distance of an object in front of an optoelectronic display can also be used to identify operating gestures in an interaction region. For example, a multiplicity of input coupling sections in array form can preferably be provided in the second main body to this end, said input coupling portions covering the dimensions of the interaction region. By determining the intensity by means of an appropriate detector array, it is possible to detect the distance of an input means (for example a hand) from the first or second main body. Advantageously, the provision of an array of input coupling portions, for example a matrix, can allow simultaneous detection of the distance of the input means at different positions in front of the first or second main body. A preferably ascertained two-dimensional distance surface allows conclusions to be drawn about an undertaken operating gesture.

In preferred embodiments, the input coupling portions can be adapted to the holographic image to be generated. For example, if a holographic keyboard is generated, it may be preferable for the input coupling portions to correspond to individual holographic keys. Pressing a holographic key can preferably be determined on the basis of a reduction in the intensity of the corresponding input coupling portion. The embodiment thus enables, in simple fashion, a reliable detection of an interaction of a user with operating elements represented by the holographic image.

The intention is to explain the system according to the invention in detail below on the basis of examples without being restricted to these examples.

### FIGURES

### Brief Description of the Figures

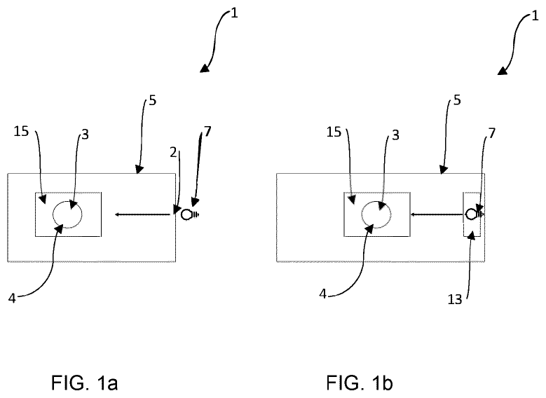

FIGS. 1a-b show illustrations of an edge-lit input-coupling of light via a first holographic optical element,

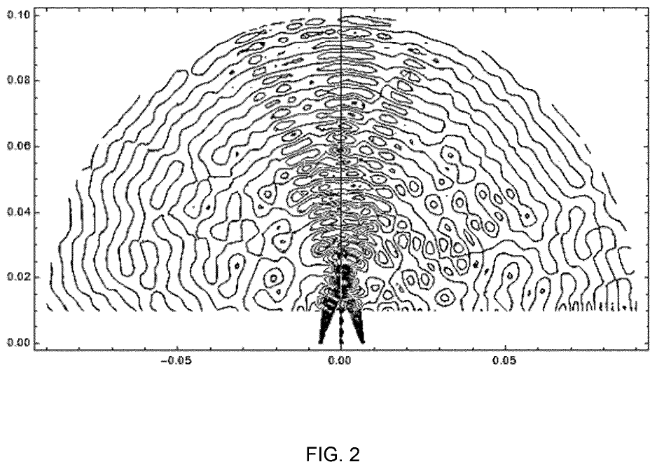

FIG. 2 shows a schematic illustration of the sound field,

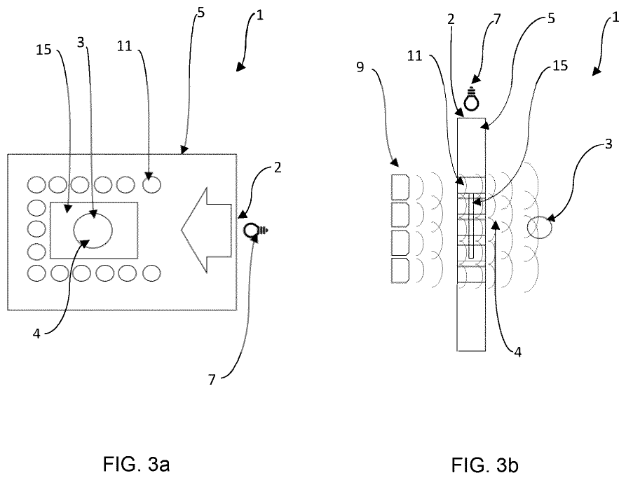

FIGS. 3a-b show illustrations of sound channels around a second holographic optical element in a plan and a side view,

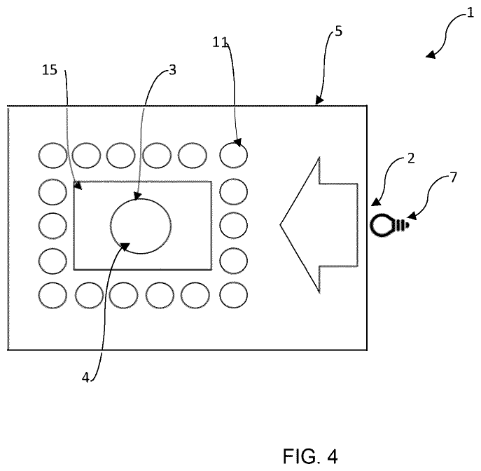

FIG. 4 shows an illustration of sound channels all around a second holographic optical element in a plan view,

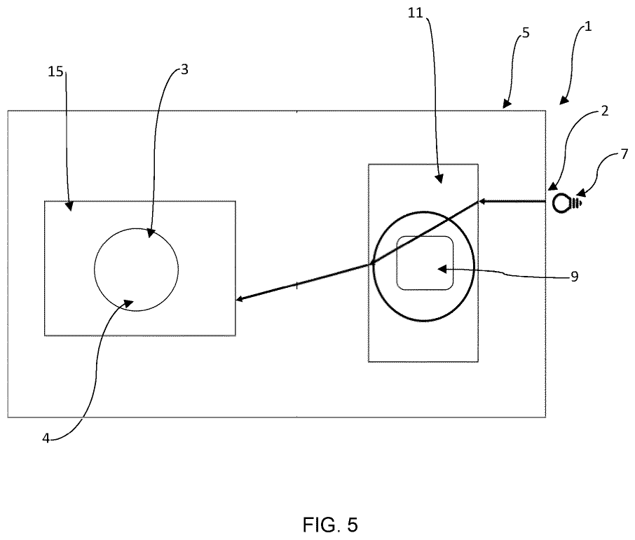

FIG. 5 shows an illustration of the system according to the invention in a plan view,

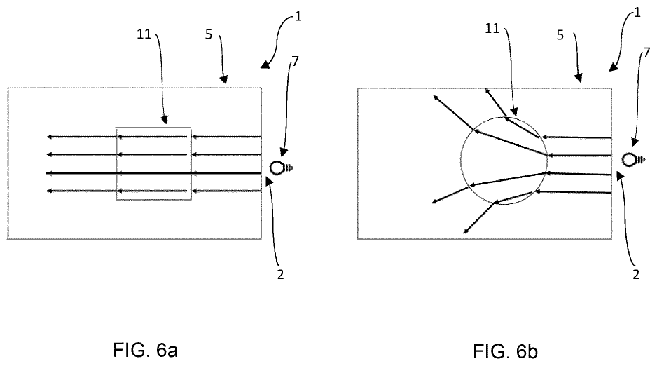

FIGS. 6a-b show illustrations of an effect of different cross sections of the sound channels on the path of the beam of light,

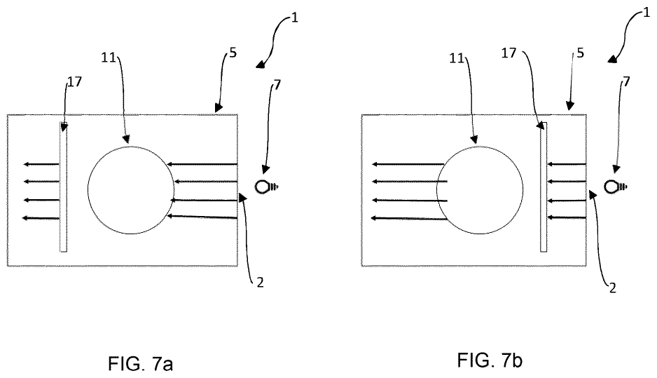

FIGS. 7a-b show illustrations of an effect of a compensation HOE,

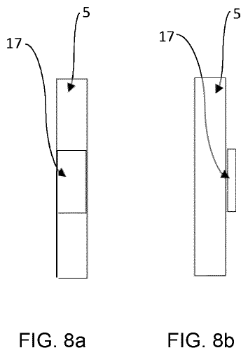

FIGS. 8a-b show illustrations of an arrangement of compensation HOEs,

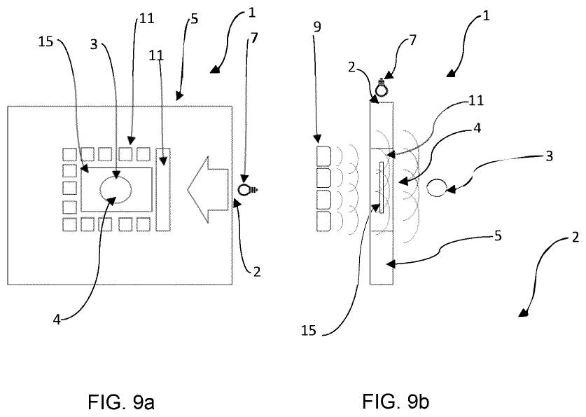

FIGS. 9a-b show illustrations of a sound channel as a gap in a plan and a side view,

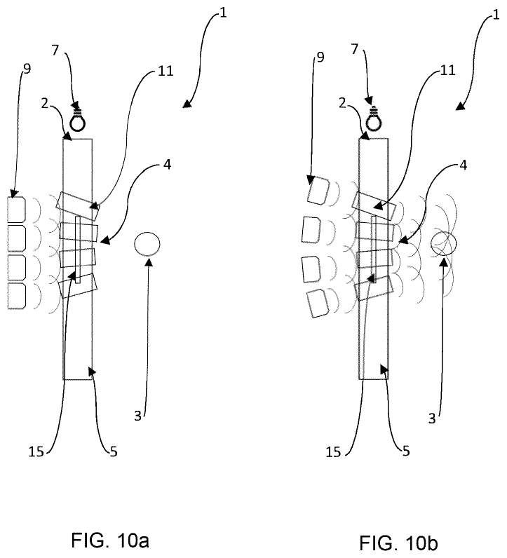

FIGS. 10a-b show illustrations of an arrangement of tilted sound channels and tilted sound transducers,

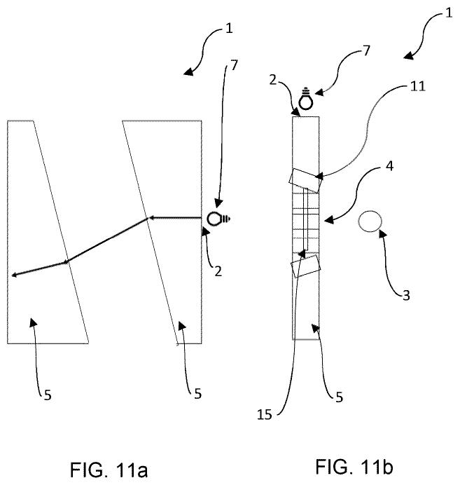

FIG. 11 shows an illustration of a path of the beam through tilted sound channels,

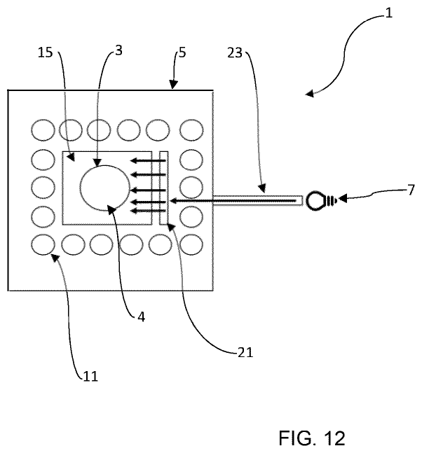

FIG. 12 shows an illustration of the system according to the invention, having a light channel and an expansion HOE,

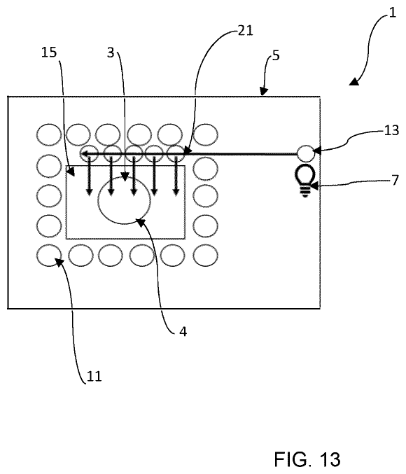

FIG. 13 shows an illustration of the system according to the invention in combination with an expansion HOE by way of a pupil dilation,

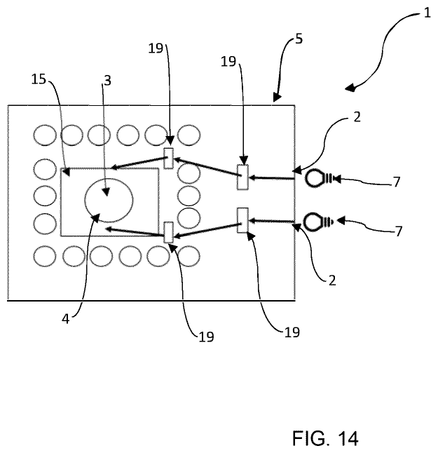

FIG. 14 shows an illustration of a possible arrangement of deflection HOEs,

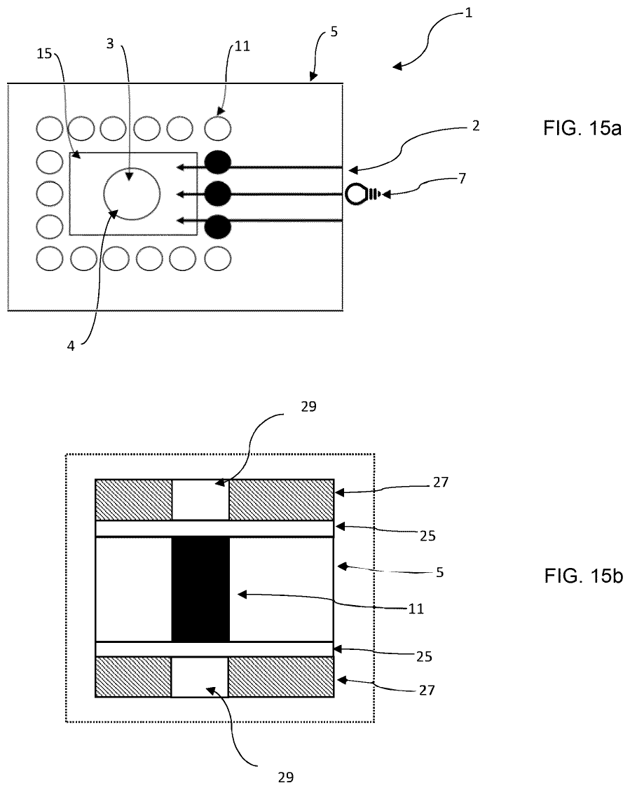

FIGS. 15a-b show illustrations of sound channels filled with a material, and

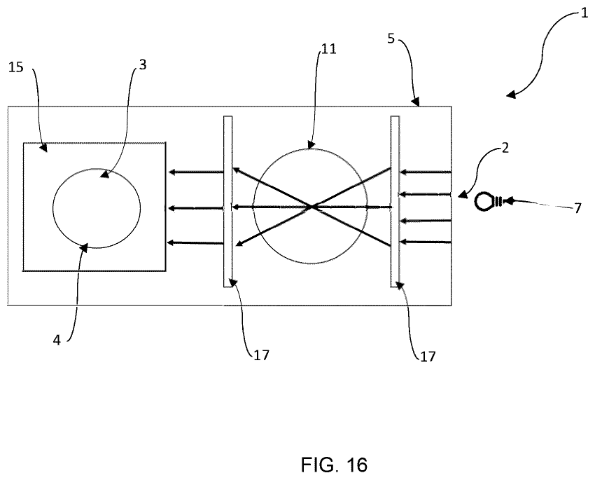

FIG. 16 shows an illustration of a plurality of compensation HOEs.

### DETAILED DESCRIPTION OF THE FIGURES

FIG. 1 shows a schematic illustration of various options for radiating and/or input coupling light into a substrate 5.

FIG. 1a represents an embodiment in which the light is let into the substrate by way of an edge-lit geometry. In this case, light from a light source 7 is emitted in the direction of a substrate 5. For example, the light source 7 can be an LED. In particular, the light can be incident on the substrate 5 laterally and be input coupled via a side, i.e. let into the substrate via an edge. Within the substrate, the light can propagate in the direction of a second holographic optical element 15, which is used to generate a holographic image 3 in an interaction region, i.e. a user can perceive a holographic image 3 optically (visually) and haptically or tactilely. In particular, the second holographic optical element 15 can be configured as an output coupling hologram, with the result that the holographic image 3 appears floating freely in the interaction region.

FIG. 1b represents an embodiment in which the light is let into the substrate 5 by way of a first holographic optical element 13. As a result of the first holographic optical element 13, the light can be input coupled into the substrate 5 with a specific wavelength (and hence a specific color) and a specific angle of incidence and can be deflected in directed fashion in accordance with the received function. In particular, the light can be steered in directed fashion in the direction of the second holographic optical element 15 in order to generate the holographic image 3 in the interaction region.

FIG. 2 shows a schematic representation of the sound field which can be generated by an emission of sound waves by sound transducers (not depicted here). Depending on the arrangement of sound channels (not depicted here), sound pressures and/or a sound pressure pattern may arise due to interference phenomena in order to obtain haptic perception. A particularly intense haptic signal can be perceived due to constructive interference in a near region in particular, while the outgoing sound waves interfere destructively in a far region, and the haptic signal is weakened and, upon leaving the interaction region, no longer able to be felt by a user. By preference, it is possible to generate defined pressure field increases, this depending on the power of the sound transducers, the arrangement of the sound channels and/or the geometric configuration thereof. By way of example, it is possible to obtain pressure field increases with a factor of up to approx. 3 between different spatial portions within the interaction region.

By the configuration of different pressure fluctuations within the interaction region it is possible to generate a particularly realistic haptic perception of the holographic image 3. For example, the holographic image 3 could represent an object such as a joystick. As a result of the system 1 according to the invention, the region of the joystick which would be grasped may have a higher pressure than a region imaging the contours. The haptic perception can give the user the impression of manually holding the object, for example the joystick, themselves. By preference, the sound transducers can use beam forming of the sound waves in order to emit the sound waves in particularly directed and focused fashion and hence also intensely at certain regions of the interaction region.

FIG. 3 shows an arrangement of sound channels which surround an output coupling region comprising a second holographic optical element 15, in a plan and side view.

FIG. 3a shows a plan view of one embodiment of the system 1 according to the invention. In this case, the sound channels 11 partly surround an output coupling region comprising a second holographic optical element 15. No sound channels 11 are arranged in a region from which the light rays or light beams emanating from the light source 7 propagate in the direction of the second holographic optical element 15 (depicted by the arrow in the figure). As a result, the light experiences no unwanted deflection, for example as a result of a lens effect that could emerge due to the sound channels 11. Instead, the light can advantageously propagate without interruption in the direction of the holographic optical element 15 in order to generate the holographic image 3 in the interaction region. The sound channels 11 are formed as openings within the substrate 5.

FIG. 3b shows a side view of this embodiment. As evident from the side view, the substrate 5 is situated between the sound transducers 9 and the interaction region. The sound waves propagate through the sound channels 11 in the direction of the holographic image 3 in order to additionally generate a haptic signal for a user within the interaction region by way of pressure fluctuations.

FIG. 4 shows an illustration, in a plan view, of sound channels 11 which completely surround an output coupling region comprising the second holographic optical element 15. In this embodiment of the system 1 according to the invention, the sound channels 11, as openings, are arranged circumferentially all around the second holographic optical element 15 such that the sound waves are able to pass through said openings and generate a particularly focused and/or wide-area haptic signal.

FIG. 5 shows a plan view of a further embodiment of the system 1 according to the invention. The light source 7 emits the light in the direction of the substrate 5. The figure shows that the light experiences a deflection while propagating through the sound channel 11. This is due to the fact that substrate material and a medium situated within the sound channel 11 may have different refractive indices. The sound transducers 9 are situated behind the substrate 5, wherein the emitted sound waves (indicated by a circle around the sound transducer 9) pass through the sound channels 11.

In particular, ultrasound waves can be emitted by the sound transducers. When ultrasound is used, the tactile or haptic sensation for a user is triggered by sound pressure fluctuations in the interaction region. In this case, ultrasound was found to be particularly advantageous for generating a particularly realistic haptic perception for the user.

The light propagates in the direction of the second holographic optical element 15 such that the holographic image 3 may appear in front of an exit or output coupling region of the substrate 5. Consequently, the system 1 according to the invention makes it possible to generate both a holographic image 3 and a haptic perception without the substrate 5 blocking or obstructing the sound.

FIG. 6 illustrates the effect of different geometrically shaped cross sections of the sound channels on the propagation of light in the substrate 5.

FIG. 6a illustrates the effect of polygonal cross sections on the light propagation. It is evident that light rays experiencing no deflection or only a small deflection is rendered possible by a sound channel with a polygonal cross section, especially a quadrilateral cross section. To this end, the boundaries of the sound channel 11 are preferably oriented orthogonal to the direction of the propagation of the light rays. This is advantageous for the design of the optical unit of the system 1 according to the invention since the course of the light can be controlled particularly easily, for example by attaching optical components and/or holographic optical elements. Consequently, polygonal cross sections, especially quadrilateral cross sections, of the sound channels 11 are particularly well suited for obtaining an effective and simple path of the beam.

FIG. 6b illustrates the effect of sound channels 11 with an elliptical cross section on the light propagation. An elliptical cross section of the sound channels 11 is advantageous for the propagation of sound waves since the mode spectrum is changed little or not at all in the case of an elliptical shape.

However, when passing through a sound channel 11 with an elliptical cross section (a circular cross section is shown), a light beam may lose its collimation and be refracted outwardly. Thus, an elliptical cross section may have a similar effect to a diverging lens. As explained in detail below, it is possible to provide various compensation options for collimating the light beams again.

FIG. 7 illustrates the effect of a compensation HOE 17 in preferred embodiments.

In FIG. 7a, a compensation HOE 17 is present, arranged in such a way that the light passes therethrough after passing through a sound channel 11. As a result, the light can be collimated provided the sound channel for example has the effect of a diverging lens.

FIG. 7b shows a further option for compensating possible unwanted effects of the sound channel 11 on the light propagation. In the embodiment shown, the compensation HOE 17 is arranged such that the light passes the latter first, before it passes through the sound channel 11. The compensation HOE 17 can be configured to pre-compensate the refractive effect of the sound channel, for example by virtue of the compensation HOE 17 having the optical function. The compensation HOE 17 is preferably designed such that it accepts different incoming radiation angles and correctly merges different wavelengths such that chromatic aberrations in the light propagation in the substrate are avoided.

FIG. 8 illustrates further possible arrangements of compensation HOEs 17. The compensation HOE 17 is embedded in the substrate 5 in FIG. 8a, while the substrate lies on a surface of the substrate 5 in FIG. 8b. For example, the compensation HOE 17 can be connected by laminating and/or adhesive bonding to the substrate 5, for example in the form of a film.

Incidentally, the options illustrated for connecting to the substrate 5 apply analogously to all holographic optical elements shown. By preference, the holographic optical elements can be applied on and/or in the substrate 5.

FIG. 9 shows an illustration of a sound channel 11 as a gap in a plan and a side view. A polygonal, especially quadrilateral cross section of the sound channels 11 in particular was found to be advantageous for the path of the beam since the complexity of the path of the beam is reduced.

FIG. 9a shows an illustration in a plan view in which a plurality of sound channels 11 are arranged such that these surround an output coupling region comprising the second holographic optical element 15, wherein a sound channel 11 is formed as a gap. The sound channel 11 in the form of a gap is arranged such that the light initially passes the gap before propagating to the second holographic element 15 in order to generate the holographic image 3.

FIG. 9b shows the same arrangement as that of FIG. 9a in a side view.

FIG. 10 illustrates an embodiment of the system 1 according to the invention, in which the sound channels 11 and/or sound transducers 9 are present in inclined fashion.

FIG. 10a shows that the sound channels 11 are tilted. As a result, the sound waves propagating through the sound channels 11 experience a different diffraction behavior to the case where the sound channels 11 are not tilted. In this case, a tilted sound channel 11 is distinguished by having an angle of inclination. Advantageously, this allows the sound pressure to be increased at specific positions in the interaction region, with the result that a more pronounced haptic signal can be generated.

FIG. 10b shows an embodiment of the system 1 according to the invention, in which the sound channels 11 and sound transducers 9 are present in tilted fashion. What was advantageously found here is that the sound pressure and the haptically perceivable pressure fluctuations could be increased to particular extent.

FIG. 11 shows the path of the beam and a further embodiment of the system 1 according to the invention, in which the sound channels 11 are tilted.

FIG. 11a depicts the beam path of a light ray propagating through a tilted sound channel. It is evident here that the light is refracted at the sound channel 11 since the substrate material and the material situated within the sound channel 11 have different refractive indices. Therefore, the system 1 according to the invention should preferably be designed such that the refractive effect of the sound channel is compensated, or else that the light is guided past the sound channels.

FIG. 11b shows an embodiment in which not all but some of the sound channels 11 are tilted, with the result that an elevated sound pressure can continue to be obtained in the interaction region. Advantageously, this leads to an intense haptic perception of the holographic image 3.

FIG. 12 illustrates an embodiment of the system 1 according to the invention in which an expansion HOE 21 is arranged. Furthermore, the system 1 according to the invention comprises a light channel 23. The light source emits light in the direction of the light channel 23. Advantageously, the light channel 23 is connected to the substrate 5 in such a way here that the light is steered past the sound channels 11 in targeted fashion. As a result, the light advantageously experiences no refraction, and so there is no need for the compensation of same. Instead, the light channel 23 guides the light onward to an expansion HOE 21. The expansion HOE 21 expands the light, especially in relation to the propagation area. As a consequence, the light is steered over a large area and preferably in collimated fashion in the direction of the second holographic optical element 15 in order to display the holographic image 3.

FIG. 13 illustrates an embodiment of the system 1 according to the invention comprising an expansion HOE 21. In this case, a plurality of holographic optical elements are arranged next to one another in order to obtain a pupil dilation. The light from the light source 7 is input coupled very narrowly into the substrate 5 and deflected such that it propagates around the sound channels 11 and experiences a pupil dilation by the expansion HOE 21 in the form of a plurality of holographic optical elements. In the process, light is also expanded, wherein the light is guided, preferably in expanded and collimated fashion, to the second holographic optical element by a plurality of holographic optical elements.

FIG. 14 shows a further option for steering the light past the sound channels 11 in targeted fashion. This is particularly advantageous for embodiments in which the sound channels have an elliptical cross section since light could be refracted outwardly in this case. In the process, use is made of additional deflection HOEs 19 in order to steer the light past the sound channels 11 in targeted fashion, especially by way of total-internal reflection. Subsequently, the light reaches the second holographic optical element 15 in order to generate the holographic image 3. The deflection HOEs 19 can be in the form of transmission and/or reflection holograms here. In particular, it is also possible to use a plurality of light sources 7, in particular two light sources 7.

FIG. 15a shows an embodiment in which some sound channels 11 are filled with a material. By preference, the material has a similar refractive index to that of the substrate material. Smaller differences in the refractive indices of substrate material and the material used to fill the sound channels 11 advantageously lead to smaller refractive effect or angle changes experienced by the light on the path to the second holographic optical element 15 for the purpose of ultimately generating the holographic image 3. Oil was found to be particularly advantageous as the filling material of the sound channels 11 since oil, preferably optical oil, can be chosen with a refractive index which is able to be adapted to be particularly close to preferred optical glasses or plastics and at the same time registers a good sound transmission. Materials such as glycerin, water and/or silicone oil can also be used advantageously for filling the sound channels 11.

FIG. 15b schematically illustrates a cross-sectional view of a portion (depicted by the dashed line) of the substrate 5 which contains a sound channel 11 filled with a material, preferably a fluid. To enclose the material (depicted by the black filling), a film or membrane 25 is applied along the sound channel 11. By preference, the film or the membrane 25 is applied on both sides to the surfaces of the substrate 5 in order to close off the filled sound channels 11. By preference, the film or the membrane 25 is transparent to the light from the light source and impermeable to the enclosed material, preferably the fluid. For example, the membrane can be a silicone membrane and the film can for example be a transparent plastic film, e.g. a PMMA film (polymethylmethacrylate film), and be present in the region of the sound channels in a manner applied to the substrate surface by an optical adhesive or an OCA film (not shown here). To cover and protect the film or membrane 25, it may be preferable to apply a film lid 27 to the film or membrane 25. In the region of the sound channel 11, the film lid 27 has an opening 29 which corresponds in terms of shape and size to the shape and size of the (cross section of the) sound channel 11. By preference, the film lid 27 may consist of the same material as the substrate 5.

FIG. 16 shows an embodiment of the system according to the invention in which a plurality of compensation HOEs 17 are arranged. In this case, a respective compensation HOE 17 is situated in front of and behind a circular sound channel 11. Advantageously, this can facilitate the compensation of the light by virtue of the light being focused by a compensation HOE 17 in front of the sound channel 11 such that the light rays are incident orthogonally on the boundaries when entering and exiting from the sound channels. This allows unwanted refractive effects and imaging aberrations to be avoided particularly efficiently.

### LIST OF REFERENCE SIGNS

1 System
2 Input coupling region
3 Holographic image
4 Output coupling region
5 Substrate
7 Light source
9 Sound transducer
11 Sound channel
13 First holographic optical element
15 Second holographic optical element
17 Compensation HOE
19 Deflection HOE
21 Expansion HOE
23 Light channel
25 Film or membrane
27 Film lid
29 Opening in the film lid

1. A system for generating a haptic perception and a holographic image in an interaction region, comprising
a. a light source for emitting light;
b. a main body comprising a substrate and at least one holographic optical element with the light source and the main body being configured to generate a holographic image in the interaction region; and also
c. one or more sound transducers for emitting sound waves in the direction of the interaction region such that pressure fluctuations are haptically palpable within the interaction region,
wherein the substrate is situated between the one or more sound transducers and the interaction region, and wherein the substrate comprises one or more sound channels, sound waves propagating at least in part through the one or more sound channels in the direction of the holographic image.

2. The system as claimed in claim 1,
wherein
the system is configured to generate the holographic image using a transmission hologram and/or a reflection hologram.

3. The system as claimed in claim 1,
wherein
the substrate comprises an input coupling region and an output coupling region situated at different positions on the substrate, and wherein the light propagates within the substrate between the input coupling region and the output coupling region as a result of multiple reflections within the substrate.

4. The system as claimed in claim 1,
wherein
the input coupling region is situated at a periphery of the substrate and/or the input coupling region comprises a first holographic optical element such that light coupled into the substrate is deflected within the substrate by the first holographic optical element

5. The system as claimed in claim 3,
wherein
the output coupling region comprises a second holographic optical element and light for generating the holographic image in the interaction region exits through the output coupling region

6. The system as claimed in claim 1,
wherein
the system comprises more sound transducers.

7. The system as claimed in claim 1,
wherein
the one or more sound transducers comprise ultrasound transducers configured for a sound emission in a frequency range from 20 kHz to 100 kHz.

8. The system as claimed in claim 1,
wherein
the pressure fluctuations are generated by acoustic sound waves with a carrier frequency and a modulation frequency, with the carrier frequency preferably being between 20 and 100 kHz and/or the modulation frequency in a range between 0.1 Hz and 500 Hz.

9. The system as claimed in claim 1,
wherein
the light source is situated within or outside of the substrate said light source comprising a laser and/or an LED.

10. The system as claimed in claim 1,
wherein
the one or more sound channels comprise openings within the substrate

11. The system as claimed in claim 1,
wherein
the one or more sound channels have an elliptical and/or a quadrilateral cross section.

12. The system as claimed in claim 1,
wherein
the one or more sound channels have an angle of inclination within the substrate such that sound waves are focused on the holographic image.

13. The system as claimed in claim 1,
wherein
the one or more sound channels partially or fully surround an exit region or output coupling region within the substrate.

14. The system as claimed claims claim 1,
wherein
said one or more sound channels comprise openings within the substrate filled with a material having a refractive index substantially corresponding to a refractive index of the substrate.

15. The system (1) as claimed in claim 1,
wherein
said one or more channels comprise openings within the substrate filled with a material with a membrane or a film on the substrate at least over the region of the one or more filled sound channels.

16. The system as claimed in claim 1,
wherein
the substrate comprises one or more holographic optical elements in front of and/or behind one or more sound channels configured for a compensation deflection and/or an expansion of light propagating through the one or more sound channels

17. The system as claimed in claim 1,
wherein
the substrate comprises an input coupling region and an output coupling region the one or more sound channels at least partially surrounding the output coupling region, light passing to the output coupling region of the substrate being steered past the sound channels by one or more holographic optical elements and/or light passing to the output coupling region of the substrate being guided past sound channels by a light channel, one or more holographic optical elements expanding light and steering it in collimated fashion to the output coupling region.

18. The system as claimed in claim 1,
wherein
the substrate comprises a an optical plastic selected from a group comprising polymethylmethacrylate (PMMA), polycarbonate (PC), cycloolefin polymers (COP), cycloolefin copolymers (COC) and/or an optical glass selected from the group comprising borosilicate glass, B270, N-BK7, N-SF2, P-SF68, P-SK57Q1, P-SK58A P-BK7 or any combination of these.

19. The system as claimed claim 1,
wherein
the system comprises a detector configured to identify an operating gesture.

20. A method of using the system as claimed in claim 1 for generating a haptic perception and a holographic image in an interaction region.
